(19) United States
(12) Patent Application Publication
(10) Pub. No.: US 2001/0027890 A1
(43) Pub. Date: Oct. 11, 2001

(54) Off-road vehicle

(76) Inventors: Joseph James Bria, Danbury, CT (US); Paul E. Hammerstrom, Danbury, CT (US); Thomas C. Patterson, Westport, CT (US); Christopher Philip Dodman, Danbury, CT (US); Jared B. Floyd, New Milford, CT (US)

Correspondence Address: PENNIE & EDMONDS LLP, 1667 K STREET NW, SUITE 1000, WASHINGTON, DC, 20006

(21) Appl. No.: 09/785,419

(22) Filed: Feb. 20, 2001

Related U.S. Application Data
(60) Provisional application No. 60/183,329, filed on Feb. 18, 2000.

(51) Int. Cl. B60K 5/00

(52) U.S. Cl. 180/291; 180/68.3; 180/312; 280/830

(57) ABSTRACT

The present invention is directed towards a vehicle for off-road use with an improved frame, rear suspension, fuel tank, air intake, and four-stroke engine. Preferably, the vehicle has four wheels and a rider sits astride thereon. The frame has twin spars and is formed of aluminum. The frame further includes a removable engine frame. In one embodiment, one spar is used as an oil tank and the other spar is a cooling fluid reservoir. A swing arm pivotally connected to the frame and rotatably supports an axle assembly. The swing arm is connected to the frame by a rear shock that is disposed on the central plane of the vehicle. The frame supports a front body panel that includes an engine, air intake that is high and forward on the vehicle. The fuel tank is configured and dimensioned to be disposed beneath a seat, and has a rear portion with a T-shaped cross-section. The engine of the vehicle has and electronically controlled fuel injectors, and has a forward air intake and a rearward exhaust.

This application is a non-provisional application of U.S. application Ser. No. 60/183,329 filed on Feb. 18, 2000, now pending, which is incorporated herein by reference in its entirety.

### FIELD OF THE INVENTION

This invention generally relates to off-road or all terrain vehicles, and more particularly to an improved four-wheel all terrain vehicle.

### BACKGROUND OF THE INVENTION

Off-road vehicles are well-known forms of transportation that are built for use on rough terrain and riding them usually includes maneuvering through trees and other obstacles. The stability, ruggedness, and maneuverable of the vehicle are important.

Conventional off-road vehicles of this type generally include a tubular frame and an engine. The frame includes an engine support assembly permanently fixed to the rest of the frame. The engine is bolted to the engine support assembly and the frame. When installed, the cylinder of the engine extends vertically and terminate so that it is within the frame. As a result, when repair of the engine is necessary, the engine is removed sideways from the frame. Removal in this manner can be cumbersome.

A fuel tank stores fuel to be burned by the engine. Conventional fuel tanks are positioned on the frame at the level of a seat or higher. This can raise the center of gravity of the vehicle to a level, which does not maximize stability of the vehicle.

A carburetor and air box are generally disposed behind engine, the carburetor mixes fuel with air, and this mixture is fed into the engine and burned. The air intake is thus at the rear of the engine. As a result, the amount of debris that enters the engine can be significant, which is undesirable.

Due to the performance requirements of off-road vehicles, they are generally equipped with a rugged rear suspension capable of cushioning the rider from jarring. Typically, the rear suspension of an off-road vehicle comprises a swing arm that is pivotally attached to the frame. The rear wheels are rotatably mounted at the free ends of the swing arm via an axle. A shock is connected between the swing arm and the frame. Since the carburetor and air box are located behind the engine, their presence greatly dictates the configuration of the shock connection to the swing arm and main frame.

Therefore, in order to overcome the shortcomings of the prior art, the invention herein provides an improved off-road vehicle frame configuration, rear suspension configuration, fuel tank placement, air intake, and a four-stroke engine.

### SUMMARY OF THE INVENTION

These desirous and advantageous features are now provided by the present invention, which relates to an off road vehicle comprising an improved frame configuration, an improved rear suspension configuration, improved fuel tank, improved air intake, and an improved four-stroke engine.

The vehicle has a longitudinally extending central plane, and at least two wheels on opposite sides of the central plane. Furthermore, the vehicle is designed to be ridden astride by a rider.

The frame has twin spars and is formed of aluminum. The frame further includes a removable engine frame for easy removal of the engine from the frame. In one embodiment, one spar is used as an oil tank. In another embodiment, the other spar can be used as a cooling fluid reservoir in fluid communication with a radiator, where the reservoir is in a horizontal portion of the spar above the radiator.

The vehicle further includes a swing arm pivotally connected to the frame at a front end. The rear end of the swing arm rotatably supports an axle assembly. The swing arm is connected to the frame by a rear shock that is also disposed on the central plane of the vehicle.

The axle assembly includes an axle that can be formed of steel, composite material, or the like. The axle assembly further includes carriers for supporting at least one chain sprocket and brake rotor disk.

The frame supports front and rear body panels. The front body panel is configured to include an air intake in the form of apertures. The air entering from the apertures is directed to the engine. Thus, the air inlet is high and forward on the vehicle. The air drawn into the intake flows between the spars of the frame and into the front of the engine and the exhaust is at the rear.

The fuel tank is configured and dimensioned to be disposed beneath the seat, and has a rear portion with a T-shaped cross-section that allows free movement of the swing arm from a fully compressed position to a fully extended position. In the fully compressed position, the shape of the rear portion of the fuel tank allows the carriers and brake rotor disks on the axle not to contact the fuel tank.

The four-stroke engine of the vehicle is fuel injected. In one embodiment, the engine is controlled by an electronic control management system, which allows the engine performance characteristics to be programmed by the user.

### BRIEF DESCRIPTION OF THE DRAWING

FIG. 1 is a right-side, perspective view of an off-road vehicle of the present invention;

FIG. 2 is a left-side, front, perspective view of the vehicle of FIG. 1;

FIG. 3 is a right-side, front, perspective view of the vehicle of FIG. 1;

FIG. 4 is a left-side, front, perspective view of a frame of the vehicle of FIG. 1, wherein an engine frame is in connected to a main frame;

FIG. 5 is a front view of the frame of FIG. 4;

FIG. 6 is a left-side, front, perspective view of the frame of FIG. 4, wherein the engine frame is in separated from the main frame;

FIG. 6A is a top view of the frame of FIG. 4;

FIG. 6B is a partial, left-side view of the frame of FIG. 4 having a swing arm mounted thereto;

FIG. 6C is a partial, left-side view of the frame of FIG. 4 having a subframe, an engine, a portion of the swing arm, and a muffler assembly mounted thereto;

FIG. 6D is a right-side view of the frame of FIG. 4 having a radiator removed therefrom;

FIG. 6E is an enlarged, left-side, perspective view of the subframe for use with the frame of FIG. 4;

FIG. 6F is a cross-sectional view of an alternative embodiment of the frame taken along line 6F-6F of FIG. 6D;

FIG. 7 is a partial, rear, perspective view of the swing arm and an axle assembly of the present invention;

FIG. 8 is a partial, front, perspective view of the swing arm and the axle assembly of FIG. 7, wherein a plurality of shock mounts are broken away for clarity;

FIG. 8A is a partial, cross-sectional view of an axle and carrier of the present invention;

FIG. 9 is an enlarged, right-side view of the vehicle of FIG. 1 showing a portion of a rear suspension up close;

FIG. 9A is a left-side view of the frame and the swing arm, wherein the swing arm is shown in two positions;

FIG. 10 is an enlarged, front, perspective view of the vehicle of FIG. 1;

FIG. 11A is a right-side view of a fuel tank according to the present invention;

FIG. 11B is a cross-sectional of a rear portion of the fuel tank taken along line 11B-11B in FIG. 11A;

FIG. 11C is a top view of the fuel tank of FIG. 11A;

FIG. 11D is a schematic, left-side view of a portion of the frame illustrating the location of the fuel tank;

FIG. 12 is a front, right-side perspective view of the engine;

FIG. 13 is an exploded, rear perspective view of the engine of FIG. 12 with a cylinder head, a monocoque cylinder and crank case and an electric starter shown;

FIG. 14 is an exploded, left-side, perspective view of the engine of FIG. 12 with a cover separated from the engine;

FIG. 15 is a cross-sectional view of the cylinder head shown in FIG. 13;

FIG. 16 is a front, right-side, perspective view the cylinder head of FIG. 15;

FIG. 17 is a bottom, right-side, perspective view the cylinder head of FIG. 15;

FIG. 18 is a rear, left-side, perspective view the cylinder head of FIG. 15;

FIG. 19 is an exploded, perspective view the cylinder head of FIG. 15;

FIG. 20 is another exploded, perspective view of a portion of the cylinder head of FIG. 15;

FIG. 21 is a top view of the portion of the cylinder head shown in FIG. 20;

FIG. 22 is a side view of the portion of the cylinder head shown in FIG. 20;

FIG. 23 is an enlarged, left-side perspective view of the monocoque cylinder and crank case;

FIG. 24 is an enlarged, right-side perspective view of the monocoque cylinder and crank case;

FIG. 25 is an exploded, top, perspective view of the monocoque cylinder and crank case, a cylinder liner and a piston;

FIG. 25a is a cross-sectional view of the cylinder and crank case of FIG. 25;

FIG. 26 is an enlarged, left-side perspective view of the monocoque cylinder and crank case having a transmission assembly cartridge and a crank assembly cartridge installed;

FIG. 27 is a left-side, perspective view of the monocoque cylinder and crank case having the transmission assembly cartridge and the crank assembly cartridge uninstalled;

FIG. 28 is an exploded, right-side, perspective view of the crank assembly cartridge of FIG. 27;

FIG. 29 is an exploded, right-side, perspective view of the crank assembly cartridge FIG. 27;

FIG. 30 is an enlarged, left-side, perspective view of the crank assembly cartridge FIG. 27;

FIG. 31 is an enlarged, right-side, perspective view of the crank assembly cartridge FIG. 27;

FIG. 32 is an enlarged, exploded, perspective view of a pressure pump assembly;

FIG. 33 is a cross-sectional view of the pressure pump assembly of FIG. 32;

FIG. 34 an enlarged, exploded, perspective view of a scavenge pump assembly;

FIG. 35 an enlarged, exploded, perspective view of a sump wing cover assembly;

FIG. 36 is an enlarged, left-side, perspective view of the transmission assembly cartridge;

FIG. 37 is an enlarged, bottom, right-side, perspective view of the transmission assembly cartridge of FIG. 36;

FIG. 38 is an enlarged, exploded, right-side, perspective view of the transmission assembly cartridge of FIG. 36;

FIG. 39 is an enlarged, cross-sectional view of the transmission assembly cartridge of FIG. 36;

FIG. 40 is an exploded, perspective view of an alternative embodiment of the crank assembly cartridge for use with a connecting rod subassembly and a lower portion of the connecting rod shown therewith;

FIG. 41 is a cross-sectional view of the crank case and the crank assembly cartridge of FIG. 40 with the connecting rod subassembly, wherein the lower portion of the connecting rod and a cover are uninstalled; and

FIG. 42 is a cross-sectional view of the crank case and crank assembly cartridge of FIG. 41 with the connecting rod subassembly, wherein the lower portion of the connecting rod and the cover are installed.

### DETAILED DESCRIPTION OF THE PREFERRED EMBODIMENTS

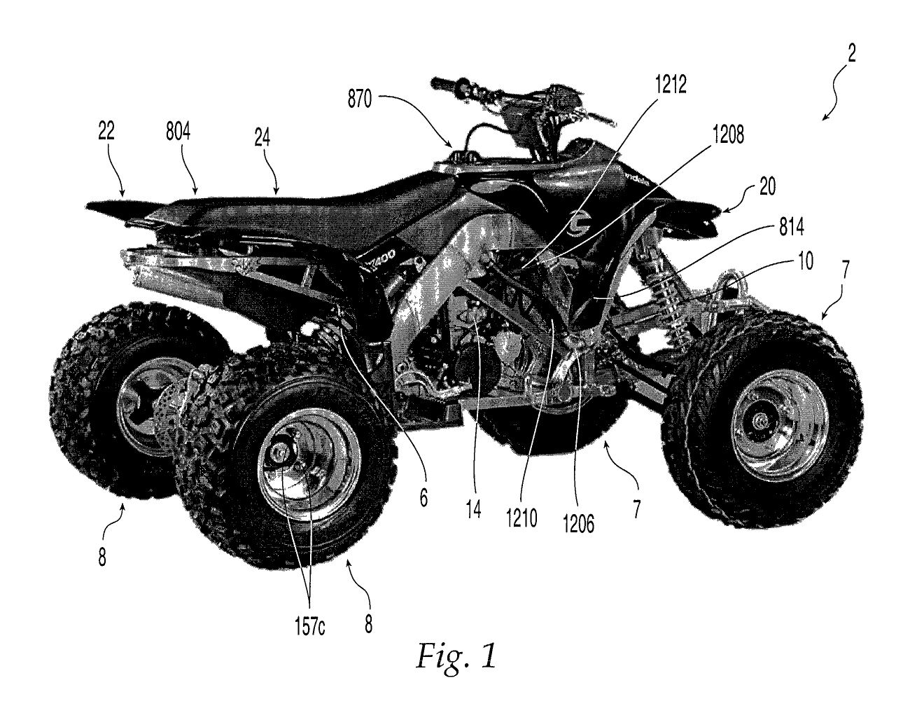

Referring to FIGS. 1-3, an off-road or all terrain vehicle 2 of the present invention includes a frame 4, a subframe 5, a rear suspension assembly 6, two front wheels 7, two rear wheels 8, a front suspension assembly 10, an engine 14, a steering assembly 16, a fuel tank 18, a front molded body panel 20, a rear molded body panel 22, and a seat 24. The frame 4 supports the other components of the vehicle 2. The frame can also support plastic, running boards for supporting a rider's feet.

In one embodiment the front and rear suspensions 10 and 6 can be symmetric about a transversely extending plane.

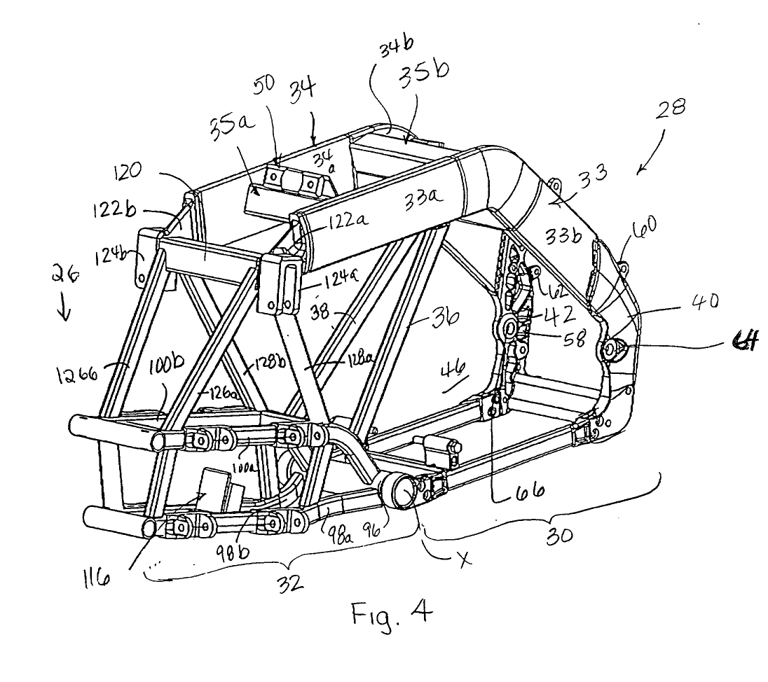

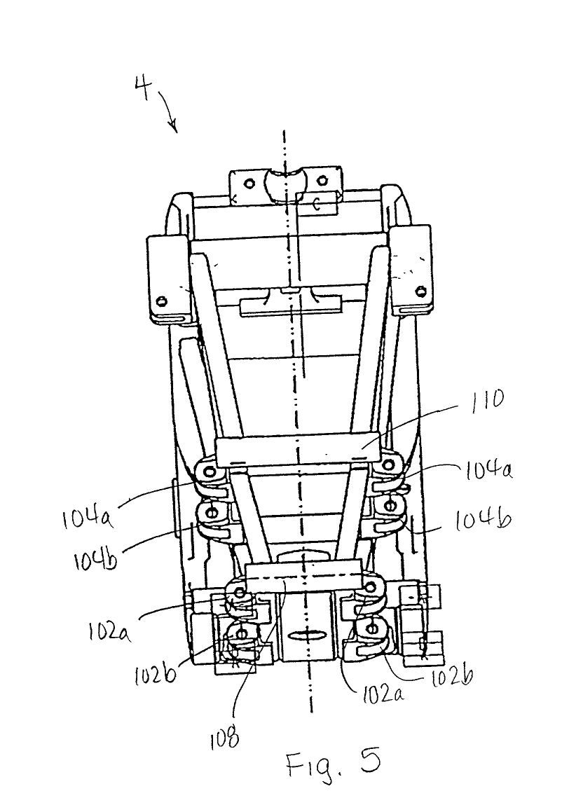

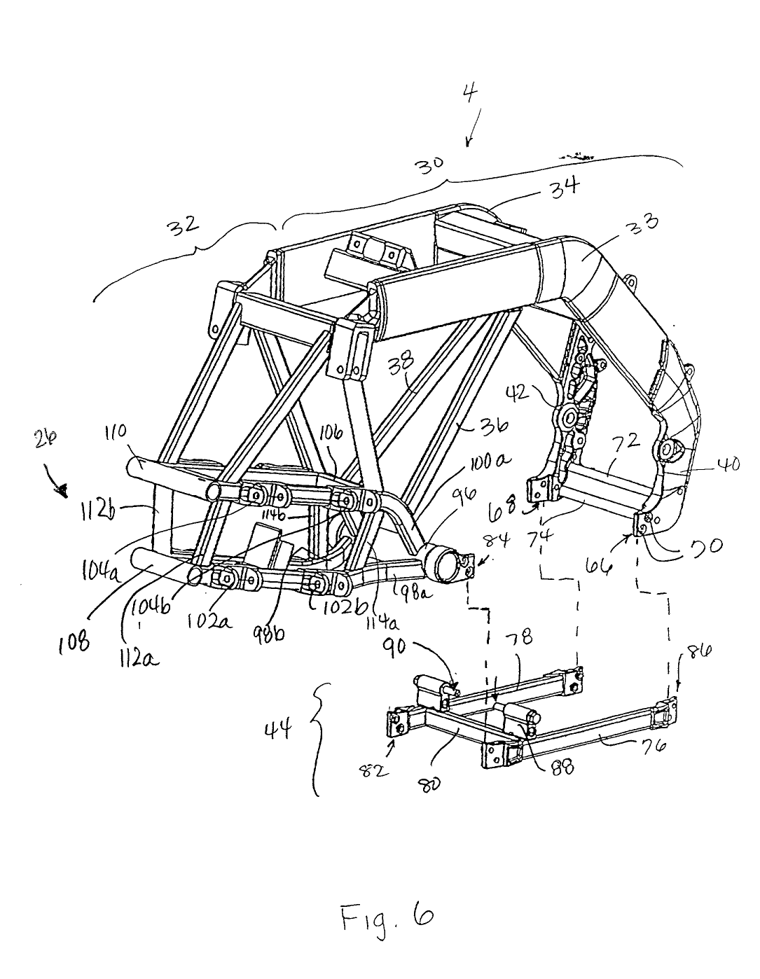

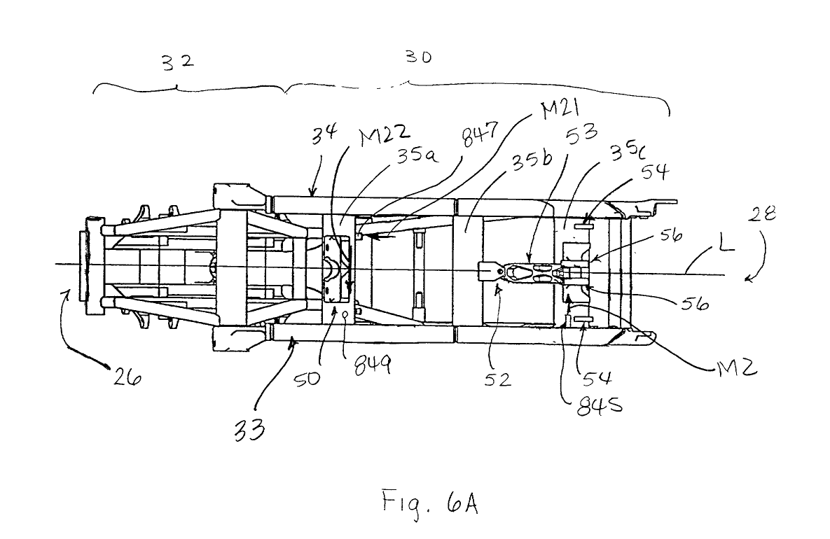

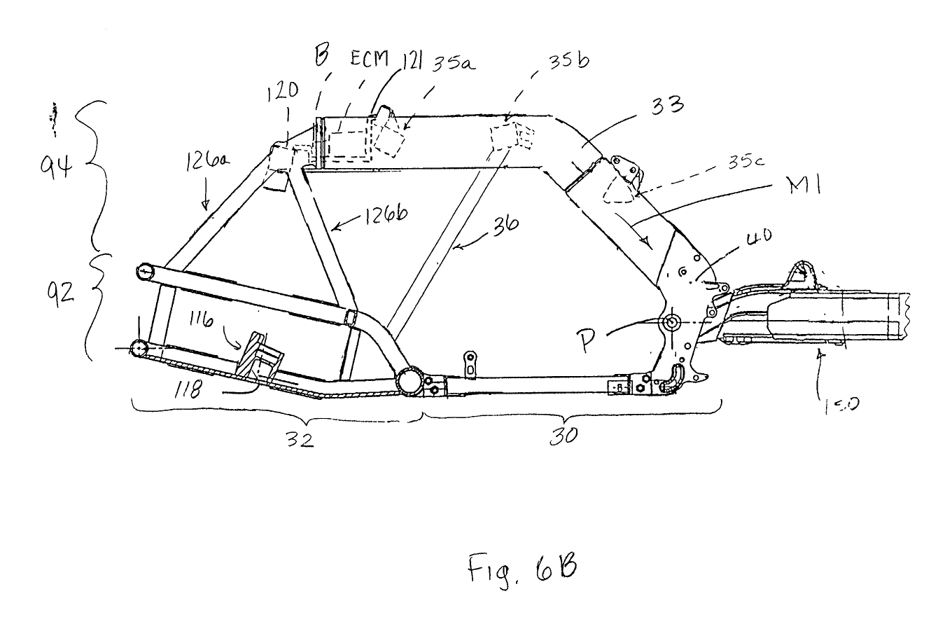

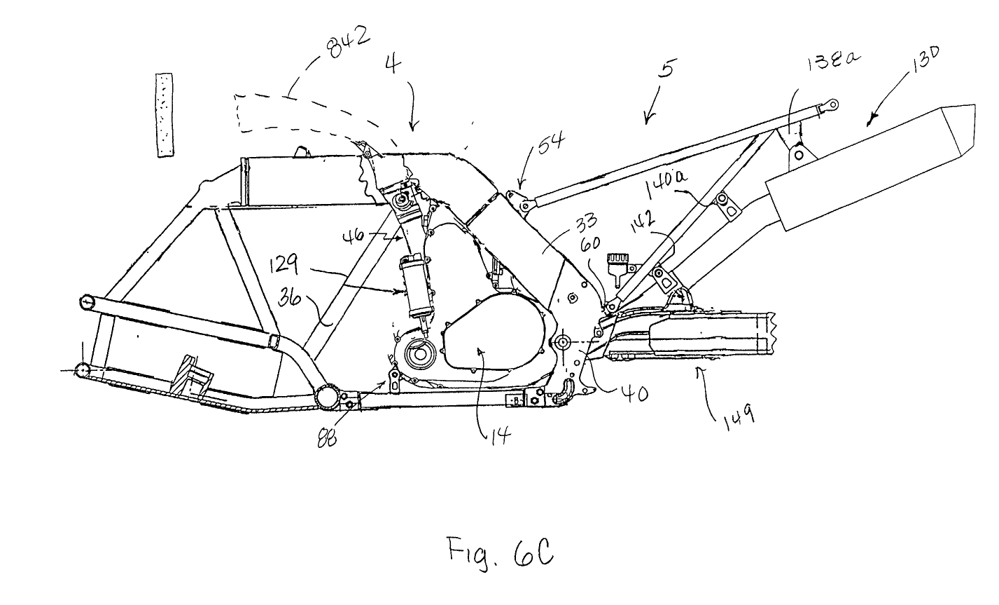

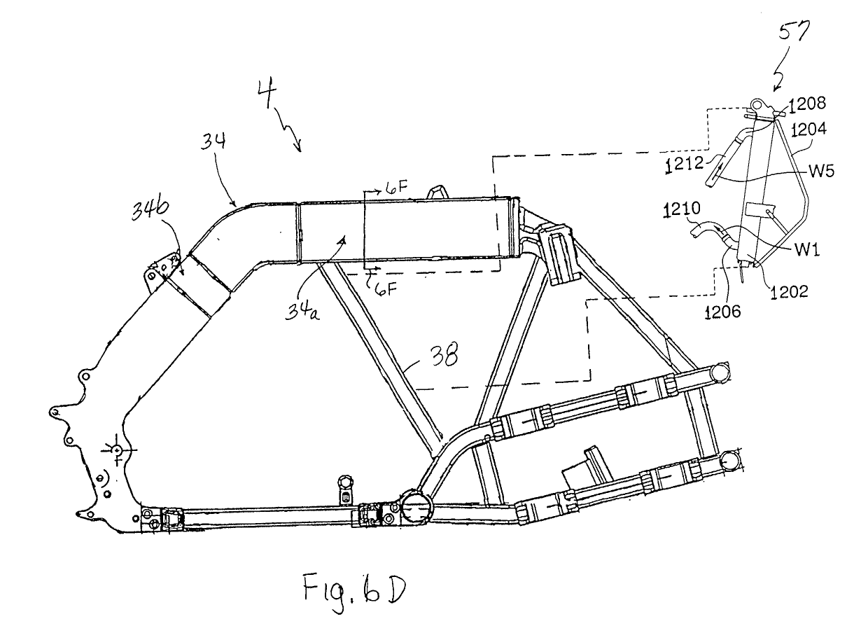

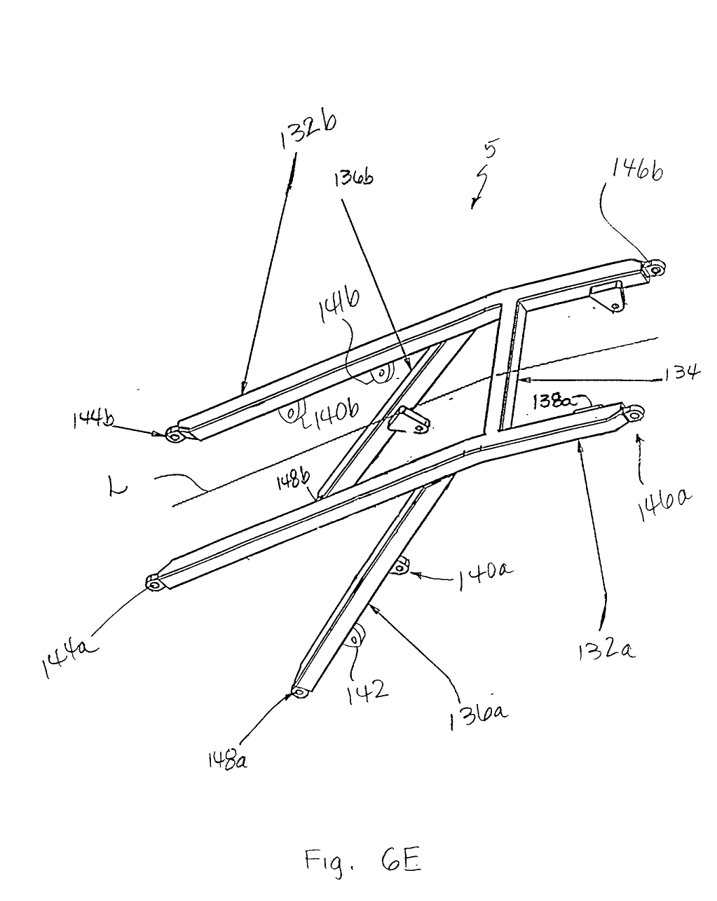

Referring to FIGS. 4-6A, the frame 4 includes a front end 26, a rear end 28 spaced therefrom, and a central plane L (as shown in FIG. 6A) that longitudinally extends between the ends 26 and 28. A rider (not shown) using the vehicle sits astride the vehicle so that one leg is on either side of the plane L and the seat 24. The frame 4 further includes a main frame 30 and a front frame 32 connected or welded thereto.

Referring to FIGS. 4 and 6A, the main frame 30 provides substantial structural support for the components of the vehicle under static and dynamic loads. The main frame 30 includes left and right or first and second spars 33 and 34, a plurality of spaced cross members 35a-c, a pair of right and left inclined members 36 and 38, left and right or first and second swing arm mounts 40 and 42, a removable engine frame 44 (as best shown in FIG. 6). The main frame components define a space 46 therein for receiving the engine 14 (as shown in FIG. 6C).

Rather than using an engine 14, as described in detail below, to power the vehicle, the vehicle can be powered by various other components such as a turbine engine. The turbine engine can also run a generator with a lithium-ion battery pack or a large capacitor so that the generator can supply power spikes. The turbine engine could be similar to a jet engine that includes an inlet, a fan, a compressor, a turbine, and an exhaust. The generator can also be similar to an alternator in a car. In the alternative, a diesel or a gas two-stroke motor can be used to drive the generator.

Referring to FIG. 4, the left and right spars 33 and 34 have a substantially rectangular cross-section and are mirror-images of one another. Extending from the front end 26 to the rear end 28 each spar 33 and 34 has a substantially horizontal portion 33a, 34a that extends rearwardly and a vertical portion 33b, 33b that extends rearwardly and downwardly therefrom.

Referring to FIGS. 4 and 6A, the cross members 35a-c extend between the spars 33 and 34 to space the spars from one another. The cross members 35a-c add rigidity to the main frame 30. The cross members 35a and b (as shown in phantom in FIG. 6B) have a square cross-sectional shape. The cross member 35c (as shown in phantom in FIG. 6B) has a triangular cross-sectional shape.

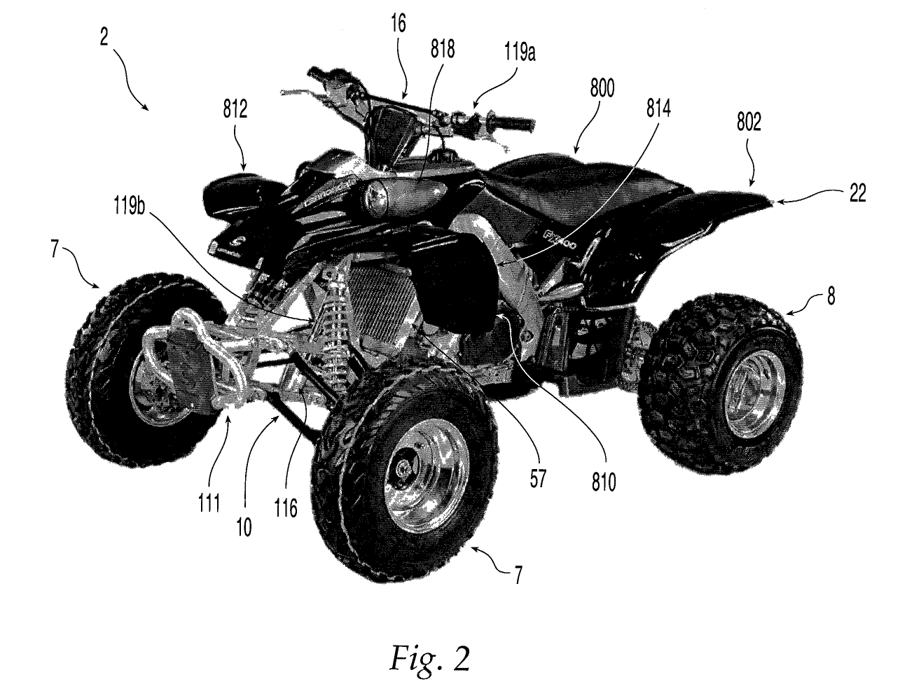

Referring to FIG. 6A, the frontmost cross member 35a includes a mounting member 50 for rotatably supporting the steering assembly 16 (as shown in FIG. 2). The central cross member 35b includes a member 52 for supporting a shock support strut 53. The shock support strut 53 extends from the cross member 35b to the cross member 35c to transmit part of the shock load. The shock support strut 53 is preferably removably attached so that it can be removed to improve access to the engine.

The rearmost cross member 35c includes a pair of subframe mounts 54 and a pair of rear shock mounts 56. The subframe mounts 54 and the shock mounts 56 extend upwardly from the cross member 35c upper surface. The shock mounts 56 are mirror-images of one another and are reinforced tabs for supporting a portion of the rear suspension assembly, as discussed below. The subframe mounts 54 are disposed on either outward side of the shock mounts 56. The mounts 54 are spaced apart an equal distance from the central plane L. The mounts 56 are spaced apart an equal distance from the central plane L. The shock support strut 53, most preferably, is attached at a first end to the mount 52 and at a spaced second end to the shock support mounts 56 on top of the cross member 35c to reduce the bending moment on the shock cross member 53 due to the shock loads. The shock support mounts 56 also retain the rear shock, as discussed below.

Referring to FIGS. 4 and 6B, the right and left inclined members 36 and 38 extend downwardly from the rearmost cross member 35c to join to the front frame 30, as discussed below. Along the inclined members 36 and 38 from rearmost cross member 35c forward, the members 36 and 38 diverge from one another. The inclined members also increase the structural rigidity of the main frame 30. In addition, as shown in FIGS. 2 and 4, the inclined members 36 and 38 support radiator 57 (as shown in FIG. 2).

Referring again to FIG. 4, the left and right swing arm mounts 40 and 42 extend downwardly from the rear ends of the spars 33 and 34, and are attached thereto. The swing arm mounts 40 and 42 are curved into a C-shape. The inner surface of each swing arm mount includes a plurality of cavities, the cavities 58 on the right mount 42 are shown. The cavities 58 help minimize the weight of the frame while allowing sufficient strength.

The outer edge of each swing arm mount 40 and 42 include a lower subframe mount 60 and 62 extending upwardly therefrom. The lower subframe mounts 60 and 62 define transversely extending bores. The inner edge of each swing arm mount 40 and 42 define bores 64 and 66 in the center thereof. The lower ends 66 and 68 (as best seen in FIG. 6) of each swing arm mount 40 and 42 define two off-set transversely extending bores 70.

Referring to FIG. 6, a pair of spaced peg cross members 72 and 74 extend between the swing arm mounts 40 and 42 close to the lower ends 66 and 68 of each mount. It is recommended that the peg cross members have a circular or an oval cross section.

Referring to FIG. 6, the engine frame 44 has a substantially H-shape and includes a pair of longitudinally extending bolt rails 76 and 78 and a transverse member 80 extending there between. Front ends 82 of the engine frame bolt rails 76 and 78 are adapted to be connected to the rear ends 84 of the front frame 32. Rear ends 86 of the engine frame bolt rails 76 and 78 are adapted to be connected to the lower ends 66 and 68 of the swing arm mounts 40 and 42.

Referring to FIG. 6 and 6C, each bolt rail 76 and 78 further includes a support 88 extending upwardly there from adjacent the member 80. Each support 88 defines a tubular section at the upper end for retaining a fastener 90. In use, the fasteners 90 extend through portions of the engine 14 to secure the engine 14 to the engine frame 44. The engine 14 is further connected to the main frame via the mount 1334 (as shown in FIG. 23) and coupled to the swing arm mounts at the holes 64 and 66.

Referring to FIGS. 6 and 6C, when the engine frame 44 is connected to the remainder of the frame 4, the engine frame ends 82 and front frame ends 84 are coupled. In addition, the engine frame ends 86 and the ends 66 and 68 of the swing arm mounts 40 and 42 are coupled. The engine 14 extends vertically between the spars 33 and 34. When the engine frame is not connected to the remainder of the frame 4, the engine frame 44 is spaced from the frame 4, so that the engine 14 is removed from the remainder of the frame so that the engine is accessible for inspection and repair.

Referring to FIGS. 4-6B, the front frame 32 includes a lower frame portion 92 and an upper frame portion 94. The lower frame portion 92 includes a transversely extending cross member 96, a pair of lower members 98a-b, and a pair of upper members 100a-b. The members 98a-b and 100a-b are joined to the cross member 96 so that the lower members 98a-b are beneath the upper members 100a-b.

The lower members 98a-b are curved inwardly from the cross member 96, and converge toward the front end 26 of the frame so that the front portions of the members 98a-b are substantially parallel to one another. The upper members 100a-b are curved upwardly from the cross member 96. A cross member 106 extends transversely between the upper members 100a-b. The portions of the upper members 100a-b forward of the cross member 106 are substantially parallel. The inclined members 36 and 38 are joined to the upper members 100a-b.

The lower members 98a-b each have a pair of brackets 102a-b formed thereon. The brackets 102a-b are spaced longitudinally from one another so that there is a forward bracket 102a and a rearward bracket 102b. The upper members 100a-b each have a pair of brackets 104a-b formed thereon. The brackets 104a-b are spaced longitudinally from one another so that there is a forward bracket 104a and a rearward bracket 104b. The forward brackets 102a and 104a on the right-side are substantially aligned and the forward brackets 102a and 104a on the left-side are substantially aligned, the rear brackets are similarly arranged.

Referring to FIG. 6, the free ends lower members 98a-b, which are closest to the front end 26 of the frame, are joined by a transversely extending lower tube 108. The upper members 100a-b, which are closest to the front end 26 of the frame, are joined by a transversely extending upper tube 110. The lower tube 108 and the upper tube 110 support a bumper assembly 111 (as shown in FIG. 2). The bumper assembly 111 can have various shapes and is connected to the tubes 108 and 110 via conventional fasteners.

Referring to FIG. 6, the lower frame portion 92 of the front frame 32 further includes two sets of vertical members 112a-b and 114a-b. The members 112a and 114a extend between the lower member 98a and the upper member 100a. The members 112b and 114b extend between the lower member 98b and the upper member 10b.

Referring to FIGS. 4 and 6B, the lower frame portion of the front frame 32 further includes a lower steer assembly support 116 disposed and joined to the lower members 98a-b. The support 116 defines bore 118. The steering assembly 16 (as shown in FIG. 2) generally includes handle bars 119a with controls, such as brake and light actuators, thereon. The handle bars are mounted on a shaft 119b. The handle bars are operatively associated with the front wheels 7 so that rotation of the handle bars causes the tires to change positions and thus a rider can steer the vehicle 2. The upper portion of the shaft 119b is rotatably secured to the mounting member 50 by a conventional bracket. The lower free end of the shaft 119b is disposed in the bore 118 of the support 116 so that the steering assembly 16 is free to rotate. In another embodiment, the steering assembly can include a steering wheel instead of handle bars.

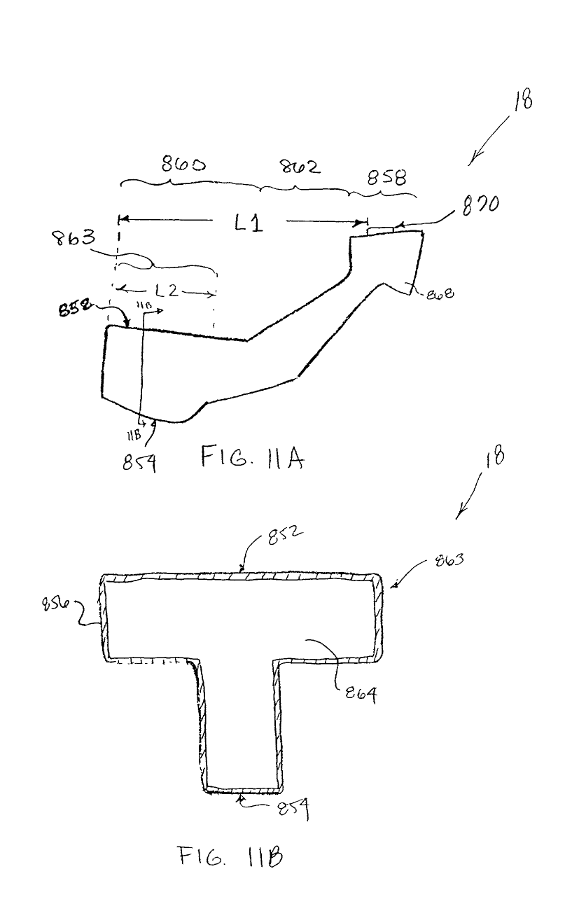

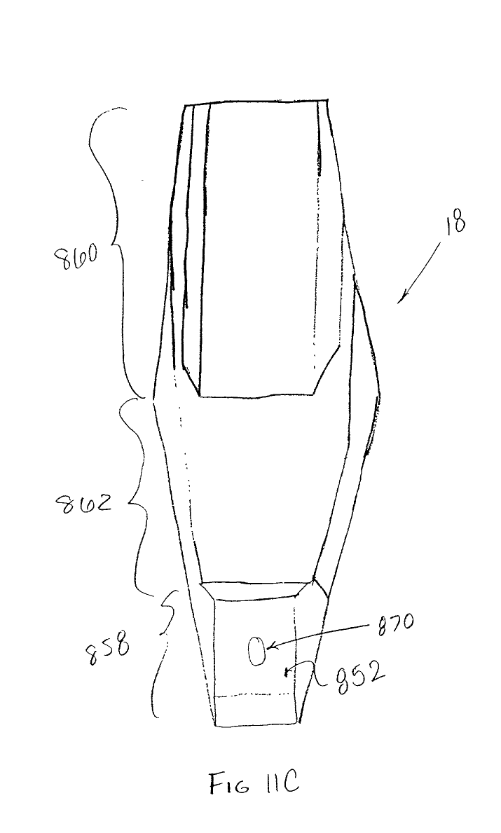

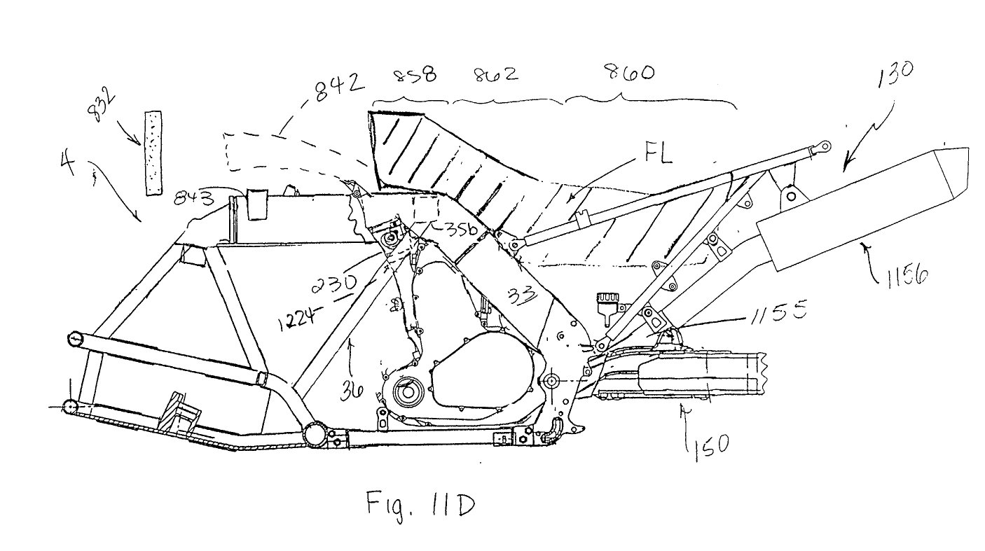

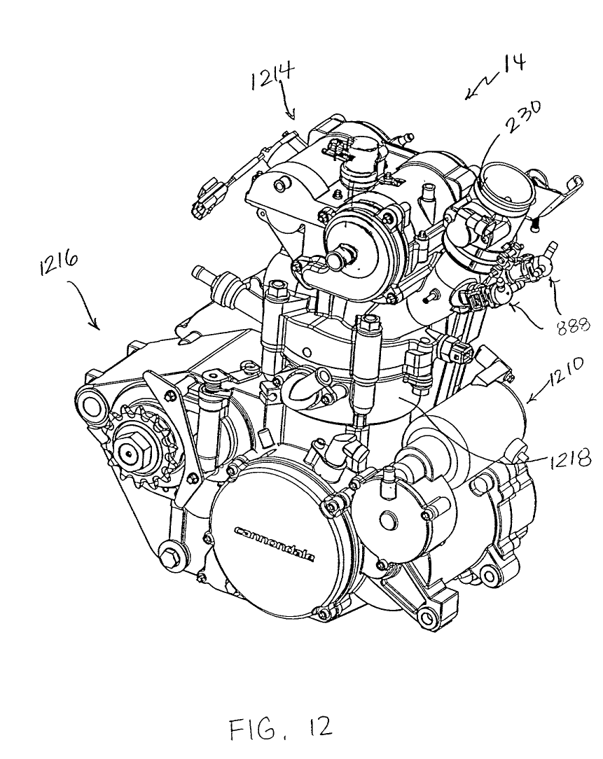

Referring to FIGS. 4 and 6B, the upper frame portion 94 includes a transversely extending cross member 120 that is joined to right and left spars 33 and 34 by members 122a and 122b. The ends of the members 122a-b are disposed within the spars and welded thereto. The free ends of the cross member 120 support brackets 124a and b. The cross member 120 has a square cross sectional shape (as best seen in phantom in FIG. 6B). A plate 121 is coupled to the cross member 120 and to the bracket (not shown) connecting the steering assembly that is connected to mounting member 50. Mounting member 50 is connected to cross member 35a. A battery B and electronic control management system (ECM) are supported by the plates 121. In addition, various other electrical components can be mounted to the plate. The battery is in electrical communication with an electronic control management system or ECM via a wire harness. In another embodiment, a plugged-in connector may connect the battery to the controller. The ECM in electrical communication with the fuel injectors 888 (as shown in FIG. 12) via a wire harness. Means may be used to secure these components to the plate, such as straps, bolts or adhesive tape (not shown) with Velcro® type hook and loop fasteners thereon.

Referring to FIGS. 1, 3, and 4, the front suspension assembly 10 includes four U shaped linkage bars that are formed by a linkage 125a, a linkage 125b, and an upright member (not shown). Each linkage bar 125a-b is pivotally coupled to brackets 102b and 104b, respectively, at one end and to the upright member at the other end. Each front wheel 7 is connected to the upright member via lug nuts 125e.

The front suspension assembly further includes two front shocks 125c. Each shock 25a includes a shock absorber and spring to bias the associated front wheel 7 away from the frame 4. The front shock 125a is pivotally coupled at one end to the bracket 124b. The other end of the front shock 125a is connected to the rear, lower linkage 125b. The vehicle also includes front disk brakes. The calipers for the front brakes are coupled to the upright member.

Referring to FIGS. 4 and 6B, the upper frame portion 94 further includes two sets of inclined members 126a-b and 128a-b. The members 126a-b extend from a forward surface of the cross member 120 forwardly and downwardly to join with the lower frame portion 32 upper members 100a-b, respectively. The members 128a-b extend from a rearward surface of the cross member 120 rearwardly and downwardly to join with the upper members 100a-b, respectively. Referring to FIG. 6C, the inclined member 36 supports fuel pump 129. The inclined member 38 supports a fuel regulator not shown. The inclined members 126a-b each support conventional, shock canisters 123 that are fluidly coupled to the front shocks 125c, and provide a reservoir for fluid expansion from the front shocks 125c.

Referring to FIGS. 1, 6C and 6E, the subframe 5 supports the seat 24, the muffler assembly 130 and the rear body panel 25. The subframe 5 includes left and right upper rails 132a-b, a subframe cross member 134, and left and right lower rails 136a-b. The left and right upper rails 134a,b are spaced apart and parallel to one another. The subframe cross member connects the left and right rails 132a-b to one another near their rear ends, and adds rigidity to the subframe 5. The left and right upper rails 132a-b include left and right upper subframe tabs 138a-b that extend downwardly and perpendicular to the respective rail.

The lower rails 136a-b are fixed by welding to the upper rails 132a-b and extend angularly downwardly therefrom. The lower rails 136a-b include lower subframe tabs 140a-b that extend downwardly and perpendicular to the respective rail. The lower rail 136a further includes a tab 142. Referring to FIGS. 6C and 6E, the upper and lower subframe tabs 138a, 140a, and 142 support the muffler assembly 130.

Each of the subframe rails 132a-b, 134, and 136a-b have a rectangular cross section. The free ends of the rails 132a-b and 136a-b narrow to terminate in subframe connectors 144a-b, 146a-b and 148a-b.

Referring to FIGS. 6C and 6E, the subframe 5 is connected to the main frame 4 so that the rails 132a-b and 136a-b extend rearwardly from the main frame 4. The front end connectors 144a-b of the upper rails 132a-b attach to the main frame spars 33 and 34 at the subframe mounts 54. The front end connectors 148a-b of the lower rails 136a-b connect to the swing arm mounts 40 and 42 (as shown in FIG. 4) at lower subframe mounts 60 and 62. Conventional fasteners are used to connect the subframe 5 to the main frame 4 and to connect the muffler assembly to the subframe.

Referring to FIGS. 6D and 6F, in one embodiment, the horizontal portion 34a of spar 34 of the frame 4 can define a chamber C. The horizontal portion 34a contains a reservoir of cooling fluid, so that the cooling fluid is above the radiator 57. The spar horizontal portion 34a includes a horizontal inner wall W that forms an upper portion of the chamber C1 and a lower portion of the chamber C2 that are in fluid communication via a hole defined in the wall W. The inlet and outlet, so labeled, are in fluid communication with the radiator and engine, as necessary, so that fluid flow F1-F3 flows into the chamber C1 through the chamber C2 and out of the spar 34.

In FIGS. 1 and 7-9, the rear suspension subassembly 6 supports an axle assembly 149 for supporting the rear wheels 8, and includes a swing arm 150, and a rear shock 151. The axle assembly 149 includes a transversely extending axle 152, a pair of axle splines 153 mounted to the free ends 152a of the axle, a pair of hubs 154 mounted to the splines 153, a pair of carriers 155, and a pair of discs 156.

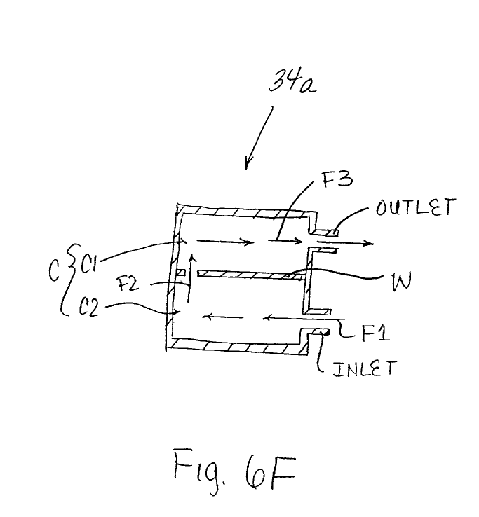

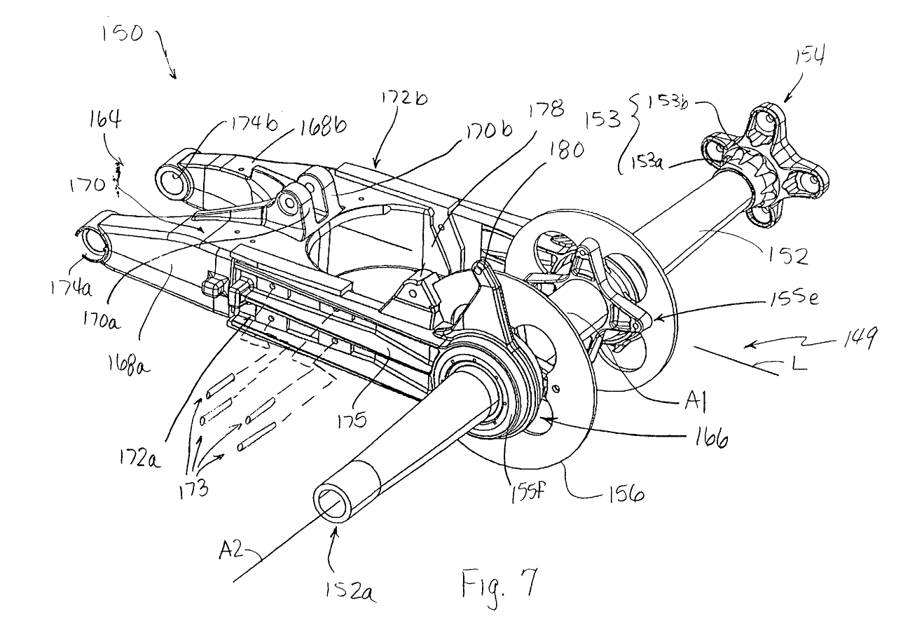

The axle 152 has a central portion C, which is aligned with the central longitudinal plane L. The splines 153 include a collar portion 153a that is bonded to the axle and a radially extending portion 153b intergrally formed therewith. The axle splines are formed of aluminum. The hubs 154 are formed separately from the splines so that the axle assembly can be serviced. The hubs 154 for each end are the same. Bolts 157a (one being shown) removably join the central portion of the hub 154 to the radially extending portion 153b of the spline 153 via holes 157b in the hub. Eight bolts 157a should be used within eight holes 157b. However, in another embodiment, the hub 154 can be formed integrally with the axle spline, but it is recommended in this embodiment to removably join the spline to the axle instead of bonding it thereto. Referring to FIGS. 7 and 1, the rear wheels 8 are connected to the hubs 154 using conventional lug nuts 157c that extend through the rim of the wheel and the hub.

In this embodiment, the axle 152 tapers outwardly from its maximum diameter at axle center, A1, to the minimum diameter at the free ends 152a. In another embodiment, the axle can have a constant diameter along its length.

In one embodiment, where the axle has a constant diameter, the axle can be formed of steel or the like. In the outwardly tapered embodiment, the axle can be formed of a composite material, such as carbon fiber or ceramic material. In one embodiment, the composite axle is formed by disposing a foam member on the outside of a mandrel. This assembly is inserted into a filament winding machine and the composite fibers are wound about the foam member at predetermined orientations. The winding pattern is selected so that the bending and torsional stiffness of the axle will meet predetermined load requirements. It is recommended that the fibers be wound at a winding angle from 0° to about 90°, where an axis A2 of the axle 152 lies at 0°. It is preferred that the fibers are wound at 20° from the axis A2. The axle can also include unidirectional material or braided material. In addition, the winding angle can be varied during winding.

Another process that can be used is to use pre-impregnated composite sheets that are laid up or rolled onto a mandrel. Then, the assembly is disposed into a female mold that forms the shape of the axle. In selecting the axle material, the bending and torsional stiffness and heat input due to the brake rotor disk bonded to the axle are considerations. In one embodiment, a KEVLAR layer or the like can be disposed over the axle to form an abrasion resistant outer surface of the axle.

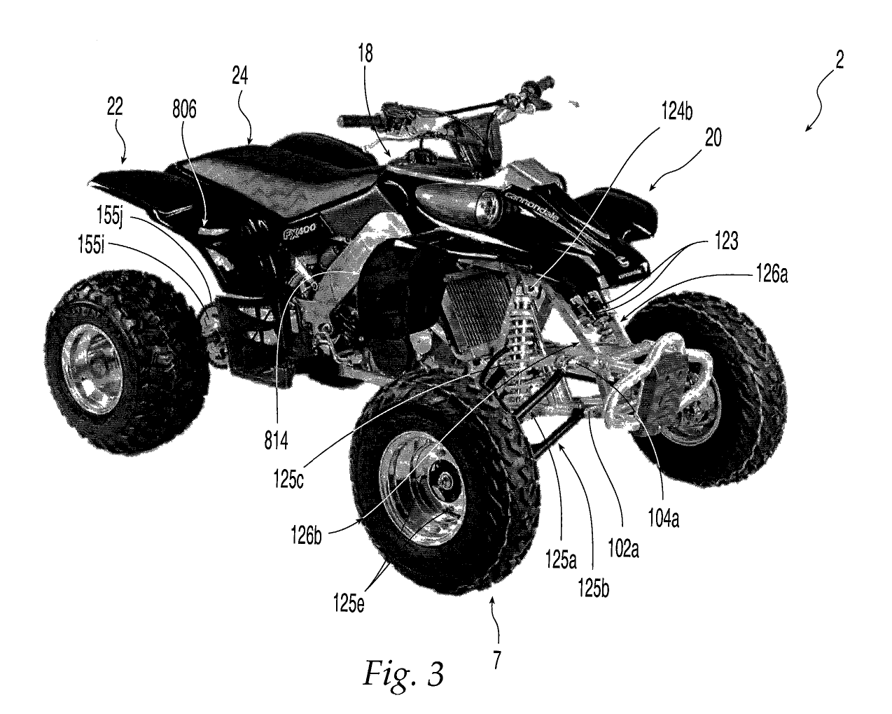

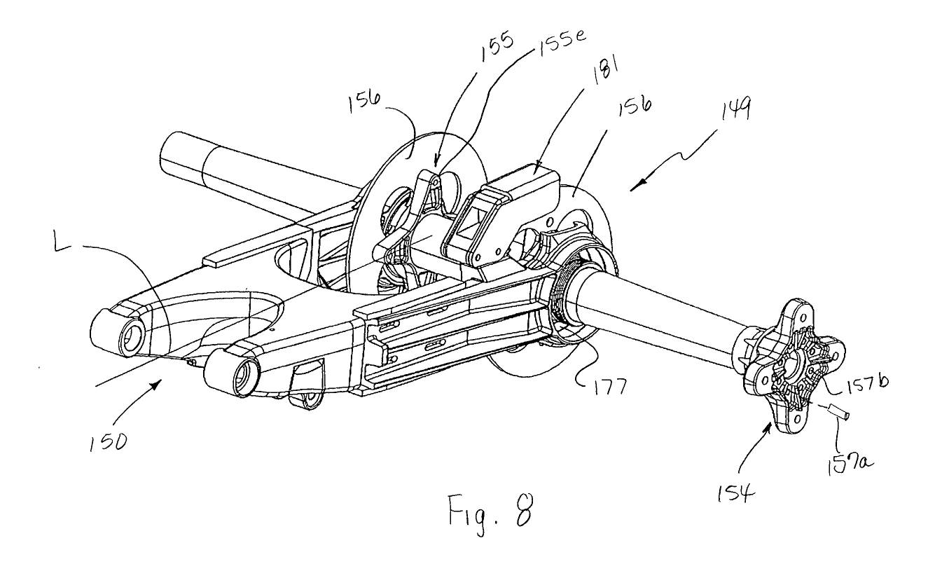

Referring to FIGS. 7, 8 and 8A, each of carrier 155 includes a collar with stepped portions 155a-d and radially extending projections 155e. The collar of the carrier 155 is bonded to the axle 152. The collar portion 155a is threaded to threadably retain a threaded, axle retaining nut 155f. The collar portion 155b supports the bearings 158 and a bearing nut 155g that has an outer sealing surface. The collar portion 155c supports bearing nut 155h that has an inner sealing surface for the bearings 158. The bearings 158 support the sprocket 155i to which a chain 155j (as shown in FIG. 3) that is operatively associated with the engine. The collar portion 155d supports the brake rotor disk 156. The projections 155e extend radially from the collar portion 155d and define holes and pockets for mounting the disk 156 thereto.

Referring to FIGS. 7 and 8, the swing arm 152 includes front end 164, spaced rear end 166, a front lug portions 168a-b, a swing arm cross member 170 that extends between the front lug portion 168a-b, and left and right stays 172a-b. The front lug portions are spaced apart and substantially parallel to one another, and a swing arm cross member 170 is formed integrally therewith to define U-shaped engine cutout 173 at the front end 164 of the swing arm 150.

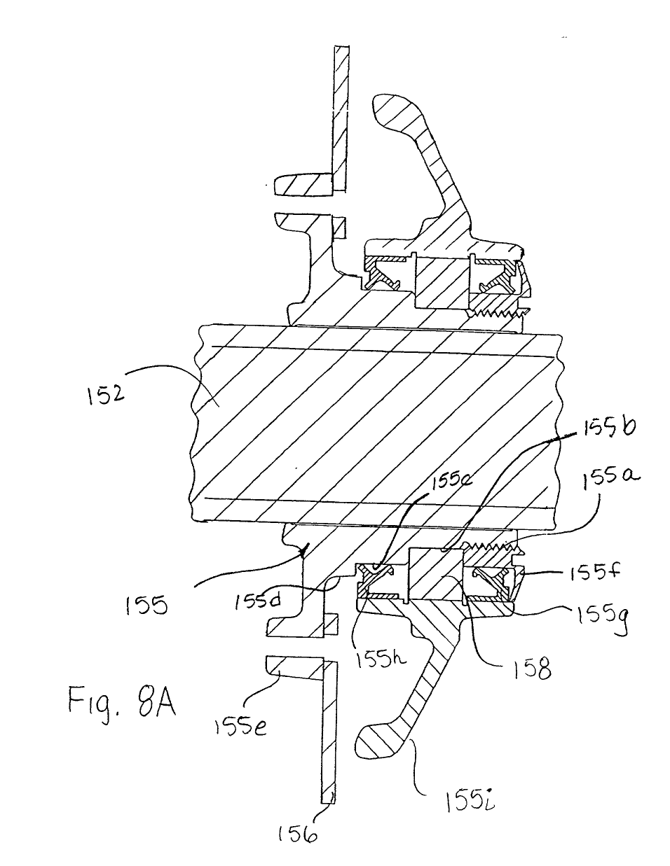

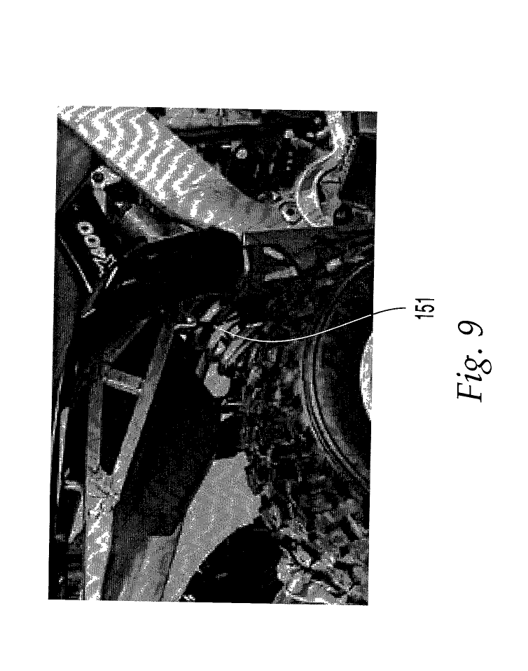

The swing arm cross member 170 includes left and right shock mounts 170a-b extending from the upper surface thereof. The left and right shock mounts 170a-b are mirror-images of one another and are reinforced tabs for supporting the shock 151 (as shown in FIG. 9). They are located on either side of the central plane L, and spaced at the equal distance therefrom. The swing arm shock mounts 170a and b are aligned with the frame shock mounts 56 (as shown in FIG. 6A). Although pairs of frame and swing arm shock mounts are shown, there may be single frame and swing arm shock mounts depending on the shock used.

The stays 172a-b are formed separately from the portions 168a-b and 170 and are connected thereto four bolts 173 for each side. The bolts extend through slots (not shown) in the lugs 168a-b to allow the stays to be adjusted longitudinally to adjust the tension on chain (not shown). The stays 172a-b include gussets or addition ribs of material 175 for adding strength to the stays. The rear lug portion 176a is disposed at the rear end 166 of the swing arm 150 and defines a bore 177 for receiving axle bearings and axle 152 therein. The left stay 172b and rear lug portion (not shown) are similarly configured.

Referring to FIGS. 7 and 8, the swing arm stays 172a-b further include mounts 178 and 180. Each swing arm has identical mounts 178 and 180. The mounts 178 and 180 support a rear brake caliper 181 so that the caliper can engage the outer surface of the disk 156 on a brake pad (not shown) mounted thereto. When the chain tension is adjusted, the caliper 181 moves with the stay.

Referring to FIGS. 4, 6B, and 7, the front end 164 of the swing arm 150 is pivotally coupled to the frame 4. The front lug portions 168a-b are coupled to the swing arm mounts 40 and 42. This pivotal coupling of the front lug portions 168a-b is achieved by using a through shaft spindle (not shown). Thus, pivotally coupling the swing arm 150 to opposite sides of the frame 4 about the pivot axis P.

The rear end 166 of the swing arm 150 moves vertically upwards and downwards as the vehicle hits bumps, as discussed in detail below. The dimensions and configuration of the swing arm should withstand the static and dynamic loads that occur during operation of the vehicle.

Referring to FIGS. 6-7, the frame 4, subframe 5, and swing arm 150 are formed of aluminum. One suitable aluminum is commercially available 6000 series aluminum. The spars 33 and 34, and swing arm mounts 40 and are cast, extruded or forged. Preferably, the main frame cross members 35a-c, subframe 5, engine frame rails 76, 78 and 80, and the front frame 32 members are extruded and machine finished. These components are welded together. The main frame and swing arm may be formed as one piece or two pieces. If these components are two pieces, each piece is a mirror image about the longitudinal axis and are welded together. It is recommended that the stays be forged and then machined.

Referring to FIGS. 7, 6A, 6B and 9, the shock 151 includes a shock absorber and spring to bias the rear or wheel end 166 of the swing arm 150, and consequently the rear wheels 8 (as shown in FIG. 1) away from frame 4. The shock 151 is pivotally connected to the main frame 30 and the swing arm 150. The shock 151 is connected to the frame shock mounts 56 and the swing arm shock mounts 170a-b, using conventional pivot pins. The shock 151 lies coincident with the central plane L along the center of the frame 4, and is attached to the middle of the swing arm 150 between the stays 172a-b.

Turning again to FIG. 9A, a number of relationships between the components result from the configuration of the frame 4. A horizontal plane is designated H. The spars 33 and 34 (one is shown) have a spar center plane M that extends longitudinally along the center of the spars. A spar angle δ is defined between the horizontal plane H and the spar center plane M. The spar angle δ is between about 40° to about 50°, and more preferably less than about 45°, and most particularly 42.7°. The δ angle is possible due to the engine lacking carburetor(s), a kick starter, and the use of the removable engine frame.

The shock 151 (as shown in FIG. 9) has two pivot axii. Referring to FIG. 9A, a front shock pivot axis is defined as S_{F}. A rear shock pivot axis is defined as S_{R}. A shock plane, designated S_{I}, and extends between the front pivot axis S_{F} and the rear pivot axis S_{R}.The swing arm 150 is shown in two positions I and II. In position I, shock is in a fully extended position. In position II, the shock is in a fully compressed position. The swing arm 150 has a central plane extending longitudinally therethrough which is designated SA_{I} in position I and SA_{II} in position II. The angle of travel for the swing arm 150 from position I to position II is defined as trave; angle θ between the swing arm planes SA_{I} and SA_{II}. It is recommended that the travel angle θ between about 15° and about 25°, and more preferably less than about 20°, and most particularly about 17.2°.

A horizontal shock mount distance D_{H} is defined as the distance horizontally between the front pivot axis of the shock S_{F} and the swing arm pivot axis P. It is preferred that the distance D_{H} is in front of the swing arm pivot P and, preferably a distance of more than about 3 inches. A vertical shock mount distance Dᵥ is defined as the distance vertically between the front pivot axis of the shock S_{F} and the swing arm pivot axis P. It is preferred that the distance Dᵥ is above the pivot P and less than about 15 inches, and more preferably less than about 12 inches, and most preferably is about 10.8 inches. The vertical distance D from the rear shock mount S_{R} to the pivot axis P is less than about two inches.

Referring to FIGS. 1-3, the rear molded body panel 22 includes a first and second rear fenders 800 and 802. The rear fenders are located on either side of a rear portion 804 of the seat 24. The rear fenders 800 and 802 are preferably formed and located in a manner to reduce the amount of dirt that can fly up onto the vehicle and rider, while the vehicle is moving. The rear fenders 800 and 802 are substantially aligned over the rear wheels 8 and have a front rear fender portion 806 that curves downward and preferably ends slightly in front of the associated rear wheel 8.

Referring to FIGS. 2-3, 6C and 10, the front molded body panel 20 includes a central body portion 808 and two front fenders 810 and 812 on either side of the central body portion 808. Preferably, the front fenders 810 and 812 are substantially aligned over the front wheels 7 (as shown in FIG. 1). A back portion 814 of each front fender 810 or 812 curves downward and preferably ends slightly behind the front wheel. The front fenders 810 and 812 reduce the amount of dirt that can fly up onto the vehicle and rider while the vehicle is moving.

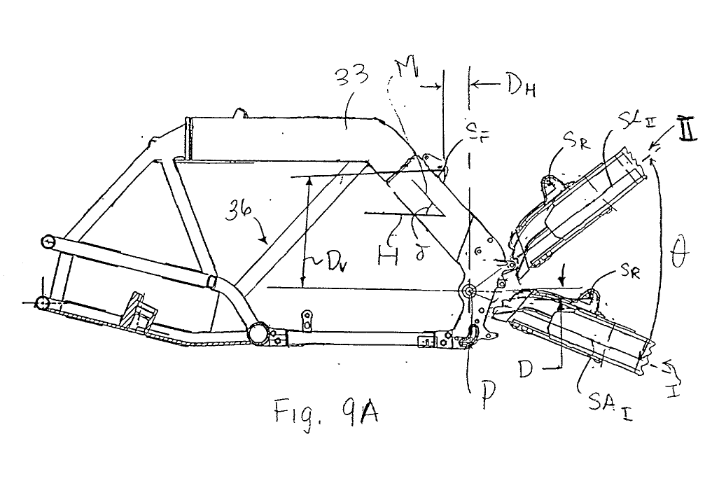

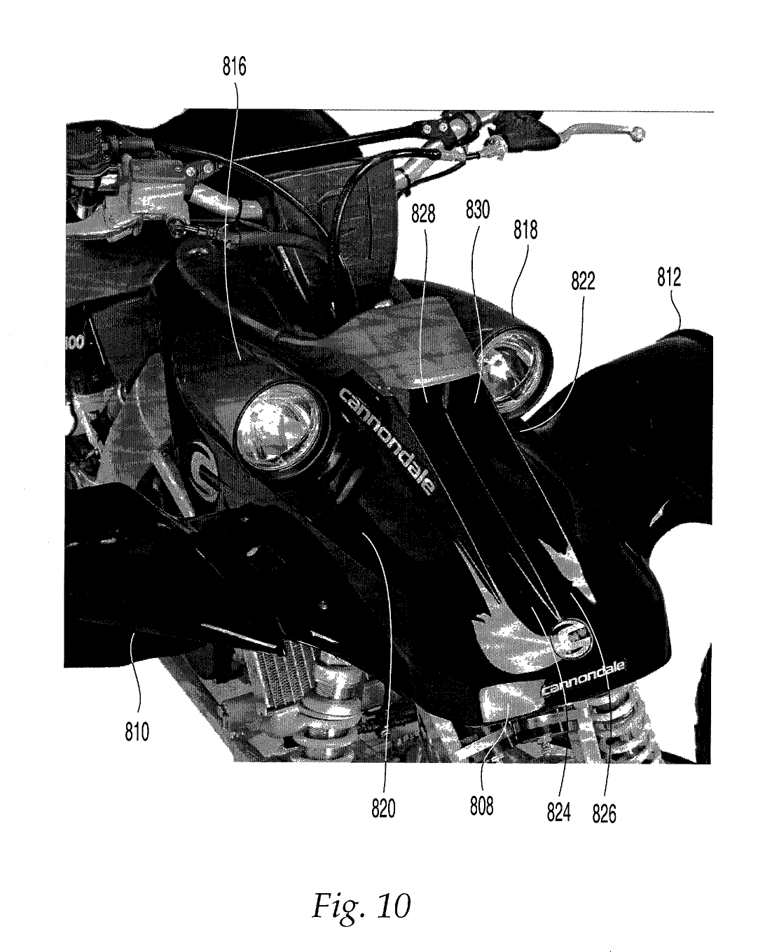

Referring to FIGS. 10 and 11D, first and second headlights 816 and 818 are located on the central body portion 808. Preferably, the headlights are disposed within elongated recesses 820 and 822 formed on either side of the central plane L (as best seen in FIG. 6A) of the vehicle. Two elongated air dams 824 and 826 are located on the central body portion 808 between the elongated recesses 820 and 822. The elongated air damns 824 and 826 direct air into two apertures or air inlets 828 and 830. An air filter 832, preferably made of foam, covers the apertures 828 and 830 providing an air source. Locating the air source high on the vehicle, helps provide the engine with cool, clean air. The air filter is supported by the frame 4 and coupled thereto using conventional means.

Preferably, the front and rear body panels 20 and 22 are formed as a single molded piece; however each panel can be formed of multiple pieces that attached together in a conventional manner. Preferably, the front and rear body panels are molded plastic. The body panels 20 and 24 are connected to the frame with conventional fasteners.

Referring to FIGS. 4, 10, 11D, in a preferred embodiment, a plenum 842 (shown in phantom) is in fluid communication with the apertures 828 and 830 of the front body panel and extends rearward between the spars 33 and 34. The forward end of the air plenum 842 is flared upwardly to create a flange (not shown). The other end of the plenum 842 is connected to the throttle body 230, which in turn is coupled to the engine air inlet 1224. The plenum 842, thus, transports air toward the engine 14. The air filter 832 is disposed over the forward end of the plenum 842 down stream of the apertures 828 and 830. The electronics are located below the air inlets and plenum.

Instead of a plenum, an air chamber could be formed between the spars 33 and 34 and a molded plastic plate (not shown) beneath the spars.

Referring again to FIGS. 6A and 11D, the left spar 33 and the cross member 35a are hollow, so that the left spar 33 acts as the engine oil tank. The left spar 33 joins with the cross member 35a so that the interiors of these members are in fluid communication.

As shown in FIGS. 6A and 11D, the left spar 33 includes an oil fill spout 843 and an oil outlet 845 spaced downwardly therefrom. The cross member 35a further includes an oil inlet 847 and an air vent outlet 849 spaced therefrom. In an alternative embodiment, an external oil tank can be fluidly connected to the engine in a conventional manner, and coupled to the frame 4.

Referring to FIGS. 1 and 11A-D, the fuel tank 18 stores the fuel that is used by the engine 14 and supports the seat 24. The fuel tank is formed by an upper wall 852, a spaced lower wall 854, and a side wall 856. The walls 852, 854, and 856 are integrally formed so that the fuel tank includes a first or filler portion 858, a second or storage portion 860 spaced from the filler portion 858, and a central or spar portion 862 that connects these portions. Referring to FIG. 8, 11B, the rear portion 863 of the fuel tank has a T-shaped cross-section. This shape allows for movement of the swing arm 150 to the fully compressed position, as discussed above, without the carriers 155 or disks 156 coming into contact with the fuel tank.

The walls of the fuel tank define an interior chamber 864. The length from the fuel inlet 870 to the end of the storage portion 860 is designated as L1 and the length of the rear portion 863 is designated as L2. It is recommended that the length of the rear portion 863 is less than the length of the storage portion so that the storage capacity of the tank is maximized. Preferably, L1 is approximately 27 inches, L2 is approximately 10 inches. Preferred volume to the internal chamber 864 is between two (2) and four (4) gallons and most preferably the volume is about 2.8 gallons. It is preferred that the volume of the storage portion 860 is greater than the volume of the filler and spar portions 858 and 862. It is recommended that at least half of the volume is beyond the filler portion. Preferably, two-thirds of the volume is beyond the filler portion.

Referring to FIG. 11D, the schematic generally shows the position FA of installed fuel tank 18. Preferably, the majority of the fuel tank 18 (i.e., the storage and spar portions 860 and 862) is beneath the seat 24 (as shown in FIG. 1). The filler portion 858 is disposed on top of the cross member 35b (shown in phantom). Metal plates (not shown) are connected to the side walls of the fuel tank. Preferably, they are bonded to the fuel tank with adhesive. Fasteners (not shown) are inserted through tabs 140b and 141b (shown in FIG. 6E) and extend through the metal plates to connect the rear portion 863 of the tank to the subframe 5. In an alternative embodiment, straps can be used to connect the fuel tank to the subframe. For example, the straps could be placed under the fuel tank and connected to the subframe.

The configuration of the fuel tank can be modified to various other shapes that are supported on the frame. The fuel tank can be connected to the frame by conventional brackets and the like.

Referring to FIGS. 1, 4, 11A and 11C, the filler portion 858 includes a lower portion 868 and a fuel inlet 870. The lower portion 868 projects downwardly between the spars 33 and 34. The remainder of the lower portion 868 is above the spars 33 and 34.

The fuel inlet 870 is disposed through the upper wall 852 of the filler portion 858. The fuel inlet 870 is an opening that introduces the fuel into the interior chamber 864 of the tank. The fuel inlet 870 is closable with a conventional fuel cap.

Referring to FIGS. 6C and 11A-11D, the interior chamber 864 of the fuel tank is in fluid communication with the fuel pump 129 via conventional fittings and conduits. The fuel pump 129, in turn, is in fluid communication via conventional fittings and conduits with the fuel injectors 888 of the engine.

The fuel tank and fuel cap are molded of plastic. It is recommended that the fuel tank is rotary molded from cross-linked polyethylene. It is also recommended that the fuel cap is vacuum formed from polypropylene.

Referring again to FIGS. 1 and 11D, the seat 25 is mounted on the upper surface 852 of the fuel tank. Preferably, the fuel tank covers the storage portion, spar portion, and a rear part of the filler portion 858 leaving the fuel inlet 870 exposed for filling the tank. Preferably, the seat 24 extends beyond the end of the fuel tank to terminate with the subframe 5. The seat provides a cushioned surface for a rider.

Referring to FIGS. 1-4 and 6C, the engine 14 extends vertically between the spars 33 and 34. As discussed in more detail below, the engine 14 is a four-stroke engine with an electronic fuel injection system instead of a carburetor. This allows the engine 14 to have a vertical arrangement that extends from the engine frame 44 upward. Referring to FIGS. 12-14, the engine 14 includes an electric starter 1210 instead of a standard kick-start, a cover 1213, a cylinder head 1214, and a monocoque cylinder and crank case 1216.

The cylinder and crank case 1216 has a single cylinder or cylinder housing 1218, and the cylinder head 1214 is coupled to the top of the cylinder 1218 to form a substantially closed, internal volume. The engine has an internal volume between 250 cc and 700 cc. Most preferably, the internal volume is about 400 cc. A movable piston, discussed below, traverses or moves within the closed volume. Referring to FIG. 3, when installed a portion of the cylinder head 1214 extends between the spars 33 and 34.

Referring to FIGS. 3, 6C, 11D, and 12, a fuel supply system includes the fuel tank 18 in fluid communication with fuel filter (not shown) and fuel pump 129. The pump 129 supplies the pressure for drawing the fuel from the fuel tank 18 and sends the fuel through the fuel filter and across the fuel injectors 888. Fuel then flows through a pressure regulator and returns to the fuel tank. The pressure regulator is of a spring loaded diaphragm type that maintains a set fuel pressure across the injectors. The regulator is not linked electronically to another component. The injectors 888 are linked to the ECM (as shown in FIG. 6B) and will pull more or less fuel from the fuel flowing across them based on the requirements of the engine. The pair of fuel injectors 888 inject the fuel from the fuel tank 18 into the air flow that enters the engine 14 from the throttle body 230.

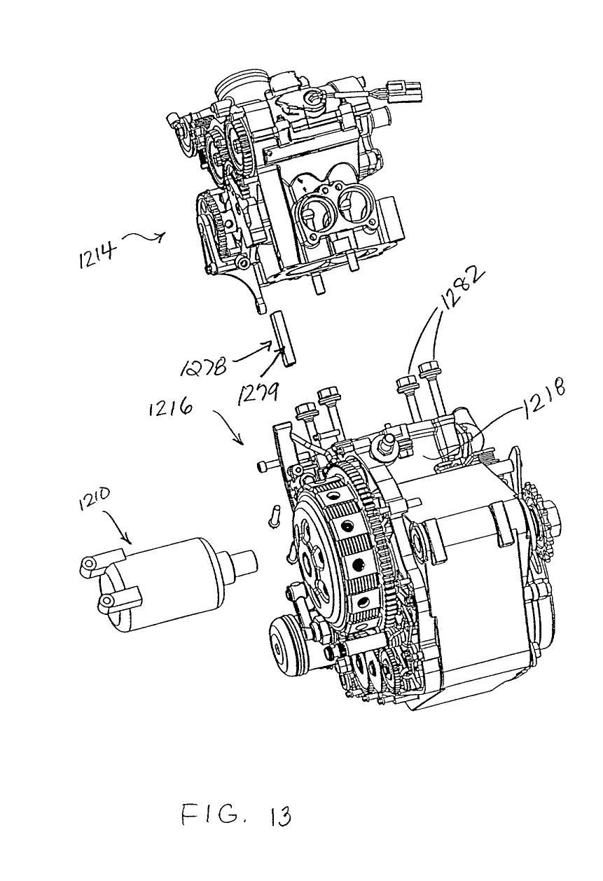

Referring to FIGS. 15 and 16, the cylinder head 1214 has the air inlet 1224 for receiving air and two inlets 1226 for introducing fuel from fuel injectors 888. The air and fuel are mixed and traverse through inlet ports 1228 for introducing the air/fuel mixture into a combustion chamber of the engine.

Referring to FIGS. 11D and 15-16, a throttle body 230 is connected to the air inlet 1224 at one end and the other end is connected to the plenum 842 at the other end. Thus, the cylinder head 1214 and cylinder 1218 (as shown in FIG. 12) are in fluid communication with the air inlets 828 and 830 (as shown in FIG. 10), and the air filters, discussed above, are upstream of the engine. Turning to FIG. 15, the fuel injectors 888 receive fuel from the fuel tank 18 and inject the fuel through fuel inlets 1226 into the air stream flowing within the air inlet 1228.

Referring to FIGS. 11D and 15, the fuel injectors 888 and throttle body 230 are in electronic communication with the ECM (as shown in FIG. 6B). The fuel is injected at a predetermined pressure, angle, and amount to produce a fuel/air mixture that is introduced into the engine 14. The ratio of fuel to air in the fuel/air mixture is controlled by the ECM, discussed further below.

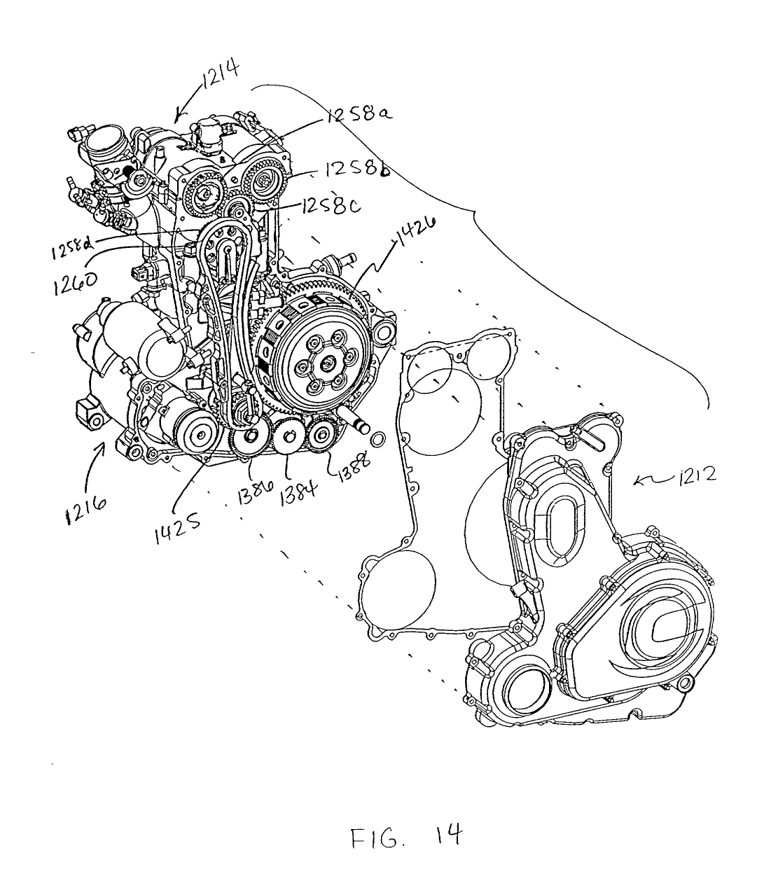

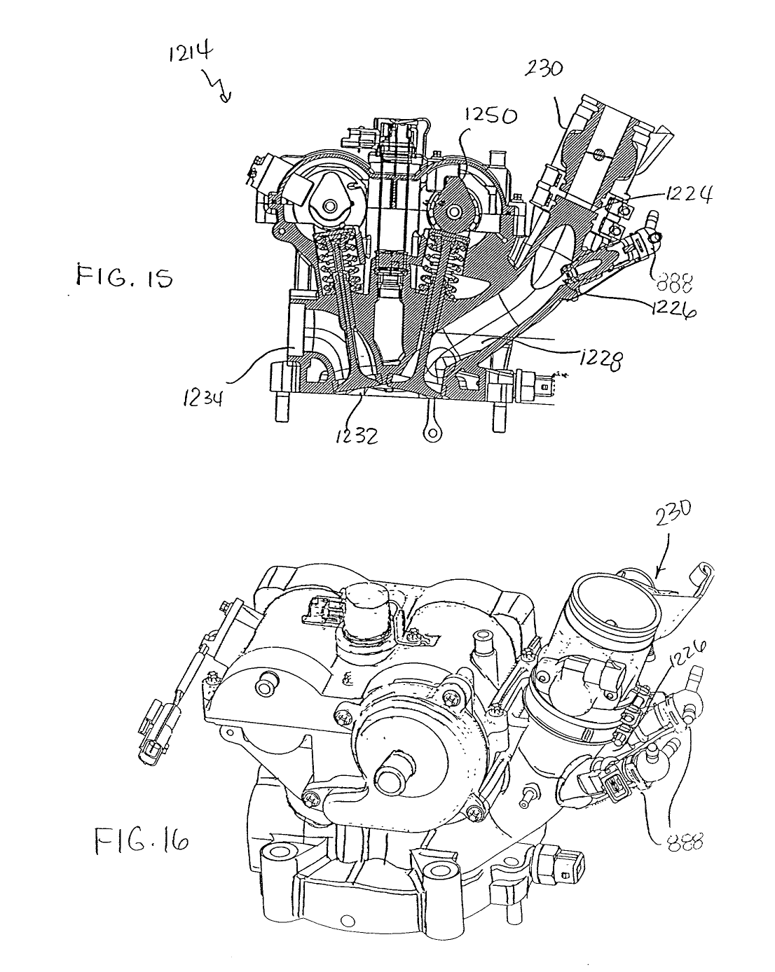

Referring to FIGS. 15 and 17, the cylinder head 1214 also has two outlets 1232 for allowing exhaust products to be removed from the closed volume. The exhaust products leave the engine through apertures 1234 (as shown best in FIG. 18) on the back side of the engine 14.

Referring to FIGS. 11D and 18, exhaust pipe 1155 is coupled to the engine to provide a passage for the engine's exhaust. The exhaust pipe 1155 is coupled to the back end of the engine at the apertures 1234, instead of the front of the engine. The exhaust pipe 1155 extends in a substantially backwards direction therefrom for the entire length of the exhaust pipe. Further, the exhaust pipe is preferably less than 50 inches long between the engine and the exhaust tip, including the collector 1235 and muffler 1156. Most preferably, as shown best in FIG. 3, the exhaust 1155 extends from the back end of the engine 14 in a substantially rearward and upward direction for its entire length. The exhaust pipe 1155 is bolted to the back of the engine cylinder head and to the subframe 5. The muffler 1156 is coupled to the subfrarne 5.

Referring again to FIG. 17, the cylinder head 1214 further includes a plurality of apertures 1236 extending through the outer wall of the cylinder head 1214. These apertures 1236 are for use with the cooling water system, as discussed below. The size of the apertures 1236 controls the amount of cooling water flow.

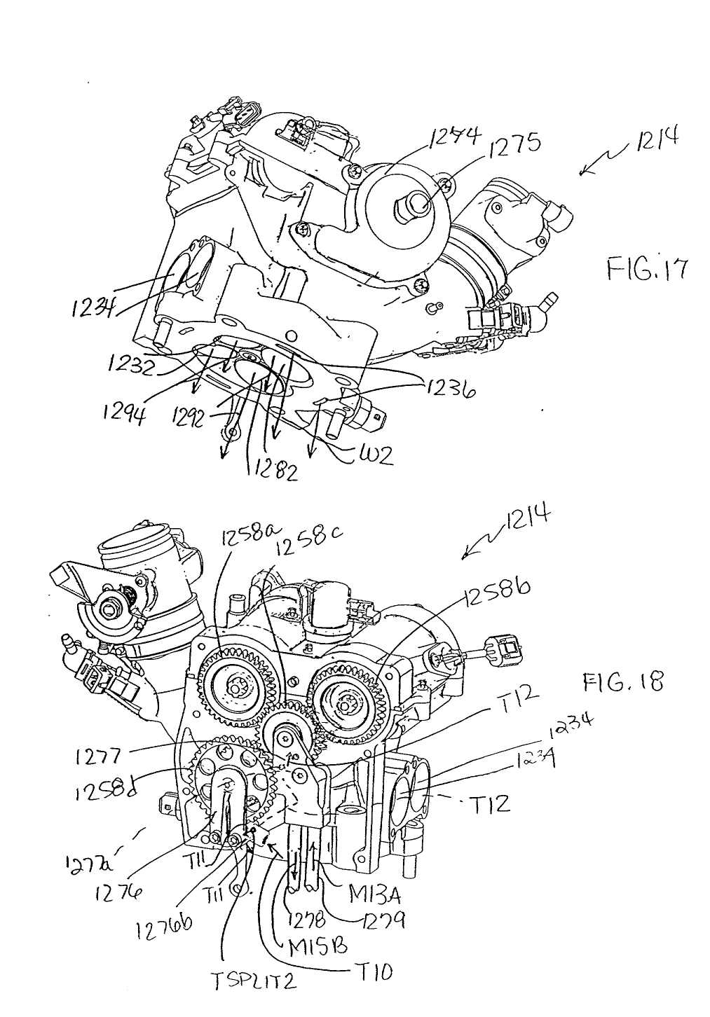

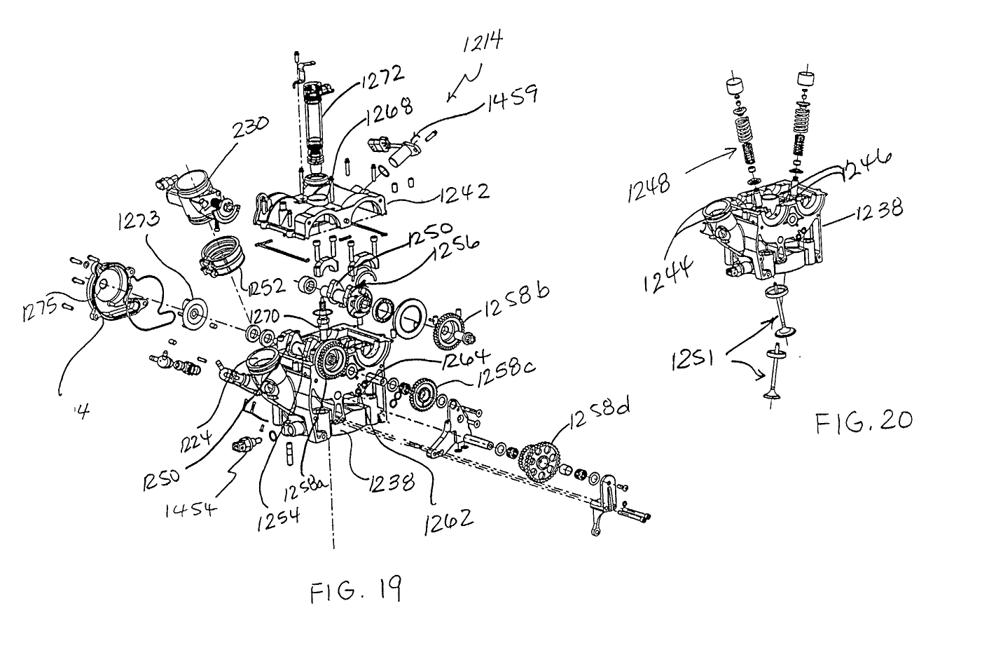

Referring to FIGS. 19-20, the cylinder head 1214 further includes a cylinder head cam bore assembly 1238 and a cam cover 1242 disposable on the assembly 1238 to define a closed cam gallery therein. The cam gallery contains the valve train.

The assembly 1238 includes the inlet valve locations 1244 and the outlet valve locations 1246. Valve cups are positioned over valve spring assembly 1248 and are biased by cams 1250 to open valves 1251.

Turning again to FIGS. 19-22, engine inlet or intake cam shaft 1254 and outlet or exhaust cam shaft 1256 are located between the assembly 1238 and cam cover 1242. A plurality of gears 1258a-d are rotatably connected to the cylinder head 1214 and operatively associated with one another. Gear 1258a rotates the intake cam shaft 1254. Gear 1258b rotates the exhaust cam shaft 1256. Gear 1258c is disposed between 1258a and b and is connected to gear 1258d which is driven by cam drive chain 1260 (as show on in FIG. 14). The cover 1213 covers the cam drive chain 1260. As the cam drive chain 1260 rotates, the cam gears 1258a-d rotate, the intake cam shaft 1254 and cams 1250 thereon rotate, and the exhaust cam shaft 1256 and the cams 1250 thereon rotate for opening and closing the valves 1251.

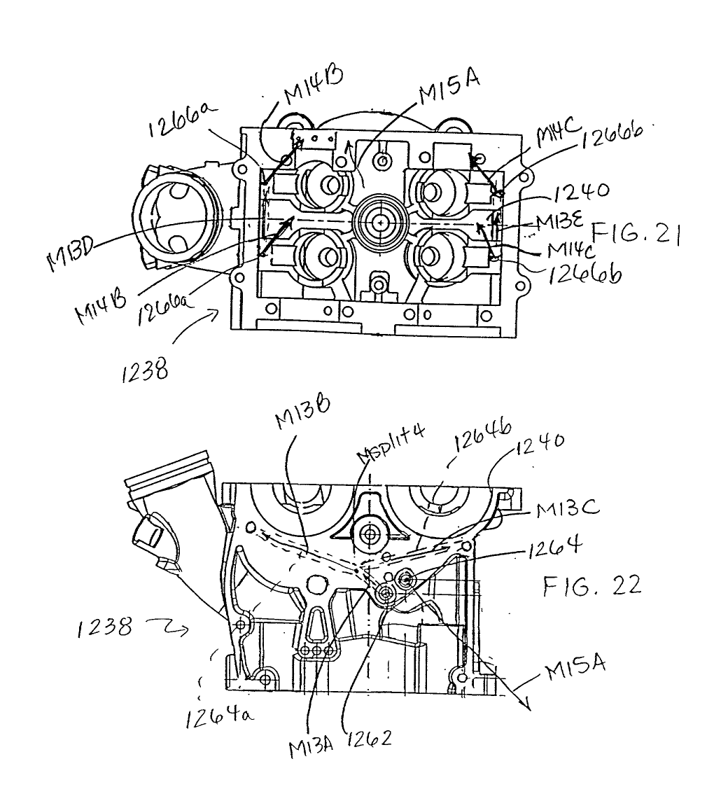

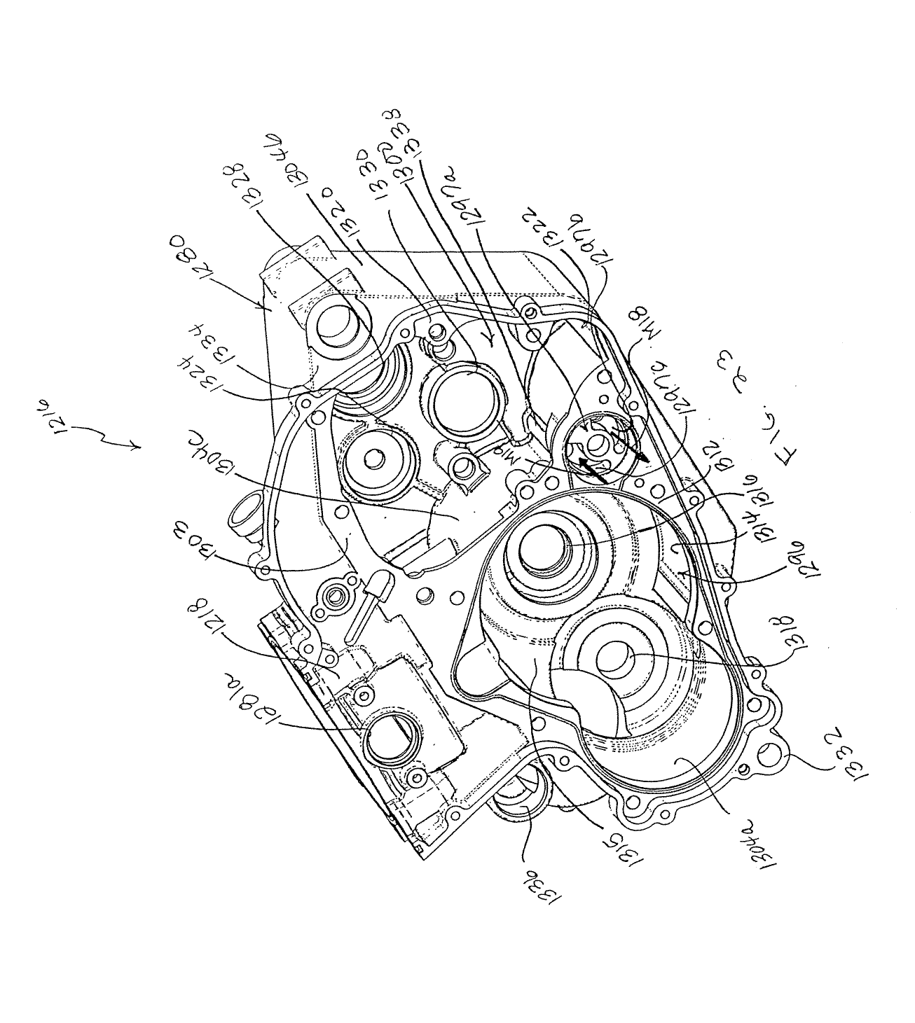

Referring to FIGS. 21-22, the cylinder head cam bore assembly 1238 further includes an inlet port 1262, an outlet port 1264, a plurality of internal passages 1264a and 1264b, and two pairs of spray ports 1266a and 1266b in fluid communication with each passage 1264a and 1264b respectively. The outlet port 1264 is in fluid communication with the cam gallery via internal passages in the assembly 1238.

Referring to FIG. 19, the cam cover 1242 further defines a center port 1268 substantially along the centerline of the cylinder head 1214 that receives spark plug 1270 and ignition coil 1272. The ignition coil 1272 and the spark plug 1270 extend down into the cylinder 1218 (as shown in FIG. 12) and ignite the air/fuel mixture for combustion.

Referring to FIGS. 19 and 15, the cylinder head 1214 further includes a water pump wheel or impeller 1273 fixedly attached to the intake cam shaft 1254. A water pump cover 1274 is connected to the side of the cylinder head 1214 adjacent the wheel 1273 so that the wheel is rotatably retained therein. The cover 1274 has an inlet 1275 in fluid communication with a cooling water inlet of the cylinder head. Referring to FIG. 6D, conduit 1210 fluidly connects the water pump cover inlet 1275 to the outlet 1206 of the radiator 57. Rotation of the cam shaft 1254 causes the water pump wheel 1273 to rotate and draw water or some other fluid up from the radiator 57.

Referring to FIG. 18, furthermore, the cylinder head 1214 includes a cam drive shaft support 1276 supported on the shaft that supports gear 1258d, and an idler shaft support bracket 1277 supported on the shaft that supports the gear 1258c. The cam drive shaft support 1276 has an inlet 1262 and internal passages that split so that one passage is in fluid communication with an outlet port 1276b and another passage fluidly connects the inlet 1262 to internal passages within the support bracket 1277. The support bracket 1277 internal passages fluidly connect the inlet 1262 to an outlet port 1277a that is beneath the gear 1258c. In addition, the cylinder head further includes two, tubular conduits 1278 and 1279.

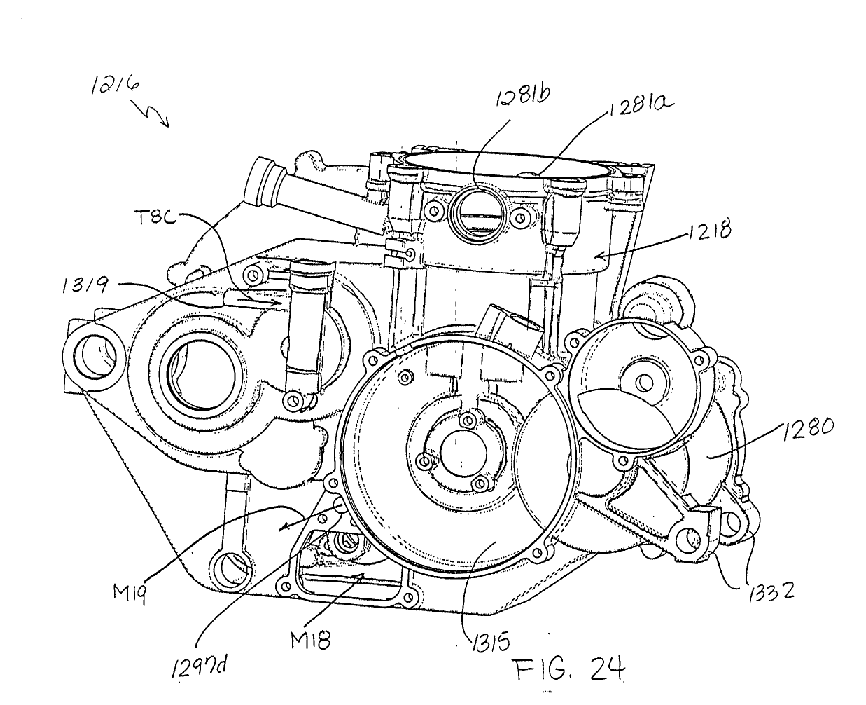

In most engines, the cylinder is one piece and the crank case is comprised of two halves bolted together so that the cylinder and crank case is a three-piece construction. Referring to FIGS. 23 and 24, in the present invention, the monocoque cylinder and crank case 1216 is a single casting or cast piece comprising the single cylinder 1218 and the crank case 1280 there below. The cylinder 1218 further includes a water outlet port 1281a and a piston access port 1281b.

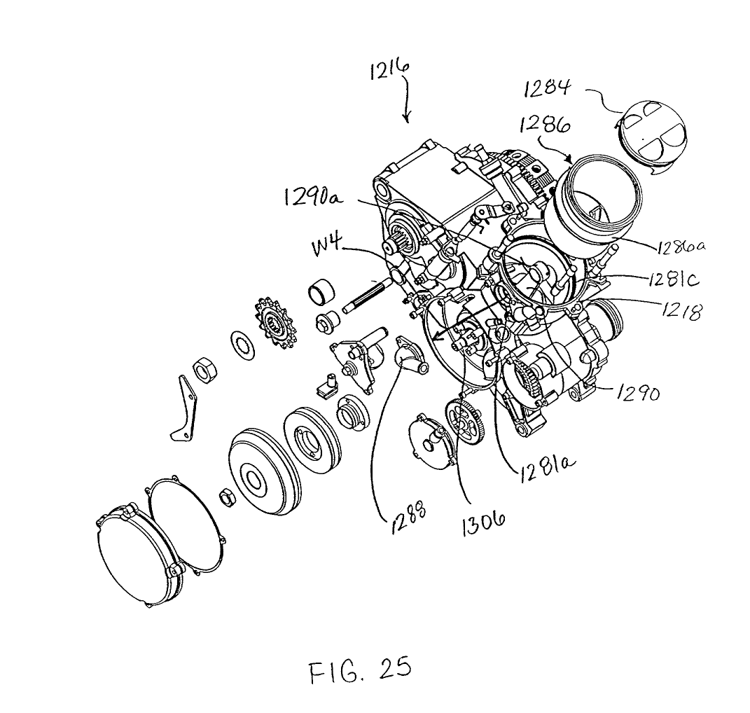

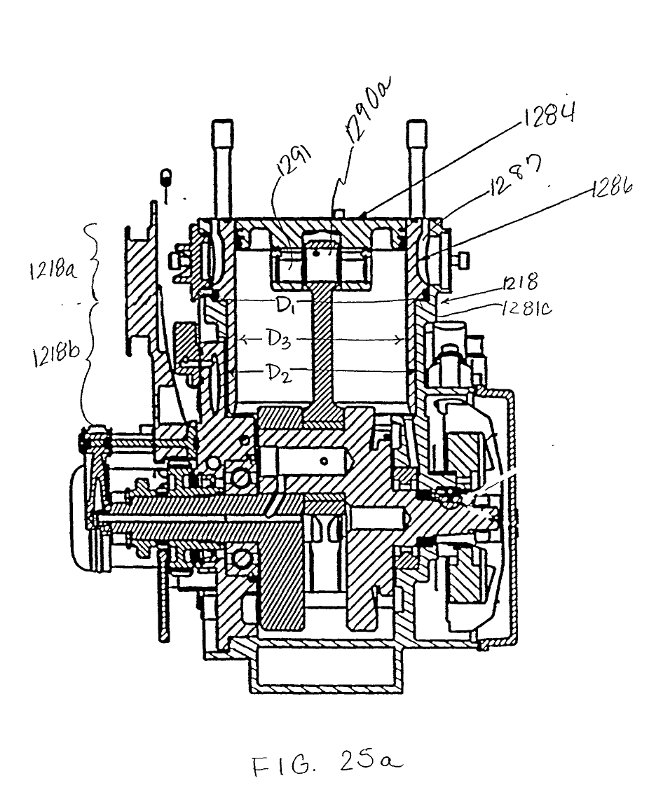

Referring to FIGS. 25 and 25a, the cylinder 1218 further includes an internal circumferentially extending ledge 1281c. The cylinder 1218 has an upper portion 1218a above the ledge 1281c with a first inner diameter D₁. The cylinder 1218 also has a lower portion 1218b below the ledge 1281 with a second inner diameter D₂. The second inner diameter D₂ is smaller than the first inner diameter D₁.

Referring to FIG. 13, the cylinder head 1214 is connected to the monocoque cylinder and crank case 1216 using conventional fasteners 1282, such as bolts. At the upper end of the cylinder a conventional O-ring gasket is disposed radially outward of a metal O-ring gasket to retain combustion gases and water in the proper locations within the engine. The metal O-ring gasket used is a tube that contains a gas, such as nitrogen, which expands when heated.

Referring to FIGS. 25, 25A, and 26, engine piston 1284 is received within the cylinder 1218 of the monocoque case 1216 along with a separate cylinder liner 1286. The liner 1286 has an inner diameter D₃ for receiving the piston 1284. The liner 1286 also includes a circumferentially extending flange 1286a. When the liner 1286 is disposed within the cylinder 1218, the flange 1286a abuts the ledge 1281c to form a seal therebetween. A conventional O-ring or gasket can be used in this area of the engine to prevent fluid communication between water in the upper portion 1218a of the cylinder and oil in the lower portion 1218b of the cylinder.

In addition, when the liner 1286 is within the cylinder 1218, a circumferential groove 1287 is formed there between. The groove 1287 is in fluid communication with the apertures 1236 (as shown in FIG. 17) and the water outlet port 1281a (as shown in FIG. 24). An elbow 1288 is connected to the port 1281a to direct the water flowing therefrom. Referring to FIG. 6D, conduit 1212 extends from the elbow 1288 to the inlet 1208 on the radiator 57.

Referring again to FIGS. 25, 25A, and 26, the piston 1284 and cylinder 1218 share the same centerline C_{L} and have the same radius. As is known in the art, coupled to the bottom of the piston is a connecting rod 1290 which is coupled to the crank and crank shaft 1306. In this embodiment, a piston pin or wrist pin 1291 connects the piston to the connecting rod. Piston rings are provided for making sure that the piston 1284 substantially fits within the cylinder 1218. As is well known in the art, the piston 1284 provides the power for the crank shaft through the combustion of the air and fuel mixture within the cylinder 1218.

Referring to FIGS. 17 and 25, air and fuel are introduced into the cylinder 1218, as discussed above, through inlet ports 1282 in the cylinder head 1214 which are opened and closed with valves. The movement of the air and fuel is represented by the arrows 1292. The piston 1284 traverses upward inside the cylinder 1218 to compress the air-fuel mixture which is then ignited to provide an internal combustion in the combustion chamber. The internal combustion pushes the piston 1284 downward within the cylinder 1218 and then the piston travels back up and the exhaust ports 1232 are opened so that the exhaust can be expelled from the closed cylinder through exhaust ports 1234. The movement of the exhaust is represented by the arrows 1294. At the top of the stroke, the inlet valves are then opened again and the exhaust valves closed so that more air and fuel can be introduced into the cylinder.

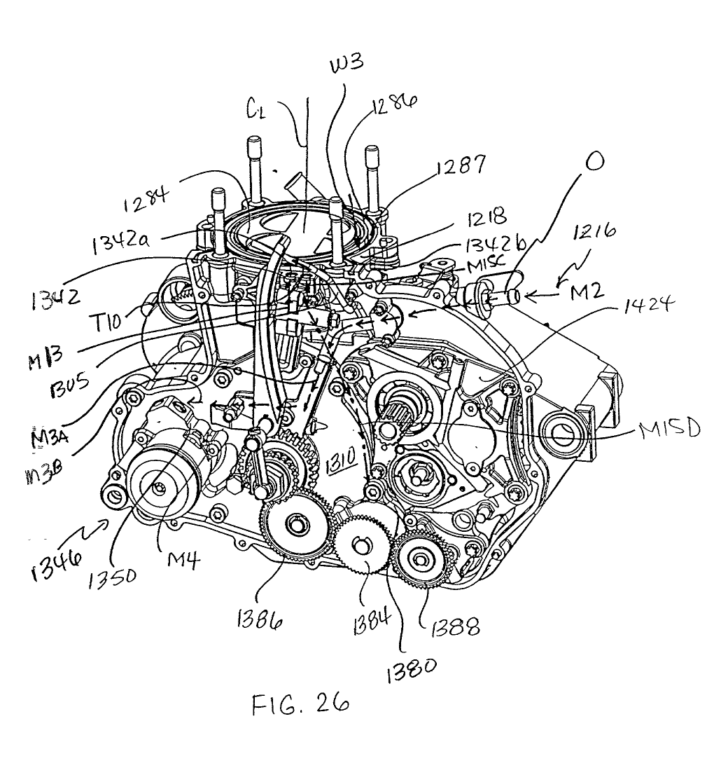

Referring again to FIG. 27, the monocoque cylinder and crank case 1216 further includes a first cavity 1296 that receives a crank assembly cartridge 1298, and a second cavity 1300 that receives a transmission assembly cartridge 1302. The first cavity 1296 has a primary opening 1296a on a first side 1301 of the case, and the second cavity 1300 has a primary opening 1300a on the first side 1301 of the case. The case 1216 further includes wall 1303 to which the cartridges 1298 and 1302 are mounted.

Referring to FIG. 23, the case 1216 also includes two spaced end walls 1304a and 1304b and an internal wall 1304c between the end walls 1304a and b that separates the crank assembly cavity 1296 from the transmission assembly cavity 1300. The walls 1304a-c are all formed as a single casting. By separating the crank assembly cavity 1296 from the transmission assembly cavity 1300, separate oil can be used with the crank assembly cartridge and the transmission assembly cartridge, respectively. Preferably, motor or engine oil is used in the crank assembly cavity and transmission or gear box oil is injected into the transmission to cool and lubricate the transmission. This improves the durability of the transmission which, in the prior art, is generally lubricated with motor oil that can break down and contain debris. The present invention also prevents clutch and gear wear products from the transmission from flowing through the engine. The preferred transmission oil has different physical properties than the motor oil. For example, the preferred transmission oil has a higher viscosity in centiPoise than the motor oil (i.e., high poit). The preferred transmission oil is a gear oil that has the viscosity of a 75W/90 and can be synthetic or not. It is recommended that the transmission oil be selected to be compatible with the clutch pack, which will determine the proper additives for the oil. It is recommended that the motor oil have a viscosity of a 10W/40 and it is preferred to use a synthetic oil. However, a non-synthetic can also be used. Referring to FIG. 26, the crank case further includes a fitting (not shown) including internal passages in fluid communication with a spray tube 1305.

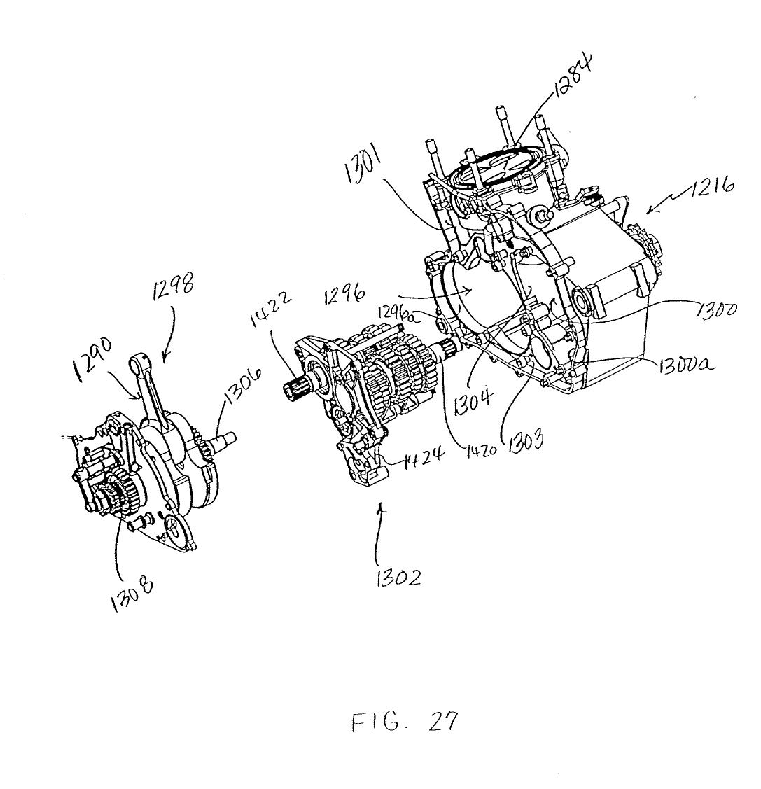

Referring to FIGS. 28-31, the crank assembly cartridge 1298 includes a crank shaft 1306, a balance shaft 1308, and a crank assembly cartridge plate 1310 to which the shafts 1306 and 1308 are coupled and through which the shafts 1306 and 1308 extend. The plate 1310 defines a plurality of internal passages for motor oil, as discussed in detail below.

Turning again to FIGS. 23 and 28, the first cavity 1296 has a periphery 1312 to which the crank assembly cartridge 1298 is attached via the plate 1310. The periphery 1312 is formed by the wall 1303 and a flange. The cavity 1296 also includes a floor 1314 and a wall 1315 spaced from wall 1303. The wall 1315 defines aperture 1316 that receives a first end of the crank shaft 1306 and defines aperture 1318 receives a first end of the balance shaft 1308. The wall 1315 also includes a passage 1319 (as shown in FIG. 24).

In this manner, the entire crank cartridge can be assembled and then inserted into the cavity 1296 of the monocoque cylinder and crank case 1216 and the plate 1310 secured to the periphery 1312 of the wall 1303. This permits easy removal of the crank shaft and connecting rod 1290 as a unit and easy repair of the crank cartridge.

Referring to FIGS. 23 and 27, the second cavity 1300 has an outer periphery 1320 to which the transmission cartridge 1302 is attached via the transmission assembly cartridge plate 1424. The periphery 1320 is formed by the wall 1303 and a flange. The cavity 1300 also includes a floor 1322. In the cavity 1300, the wall 1315 defines apertures 1324, 1328, and 1330 for use with the transmission assembly cartridge 1302, as discussed below.

Referring to FIGS. 11D and 23, furthermore, the monocoque cylinder and crank case 1216 includes mounts 1332 and 1334 for attaching the engine to the frame 4. Aperture 1336 on the right-side of the monocoque 1216 receives the starter 1210 (as shown in FIG. 12) for electronically starting the engine. The case 1216 further includes conduit 1338 (as shown in FIG. 23) formed therein that extends transversely across the case.

Referring to FIGS. 24 and 28-31, the crank assembly cartridge 1298 further includes a plurality of gears 1340, connecting rod 1290 operatively connected to the crank shaft 1306 with roller bearings, and piston access plate or cover 1342 for covering the access aperture 1281b in the cylinder. The apertures 1281a and 1281b are configured so that they are aligned with the free end 1290a of the connecting rod 1290, when the crank cartridge 1298 is installed.

Referring to FIGS. 26 and 18, the piston access plate 1342 includes vertical bores 1342a and 1342b. These bores 1342a and 1342b are in fluid communication with internal passages in the plate 1310 and the conduits 1278 and 1279, respectively so that fluid can pass there through, as discussed below.

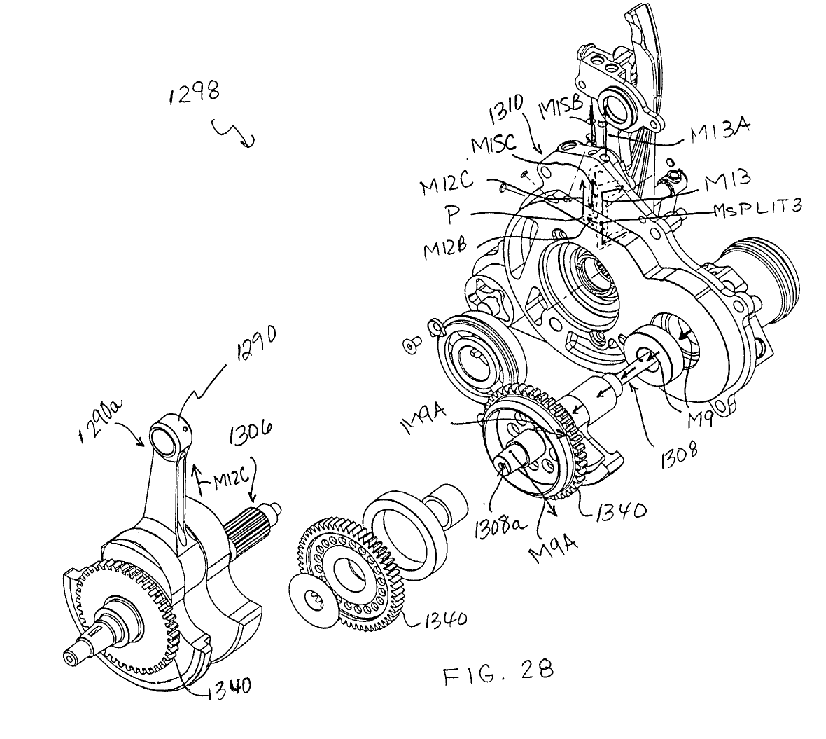

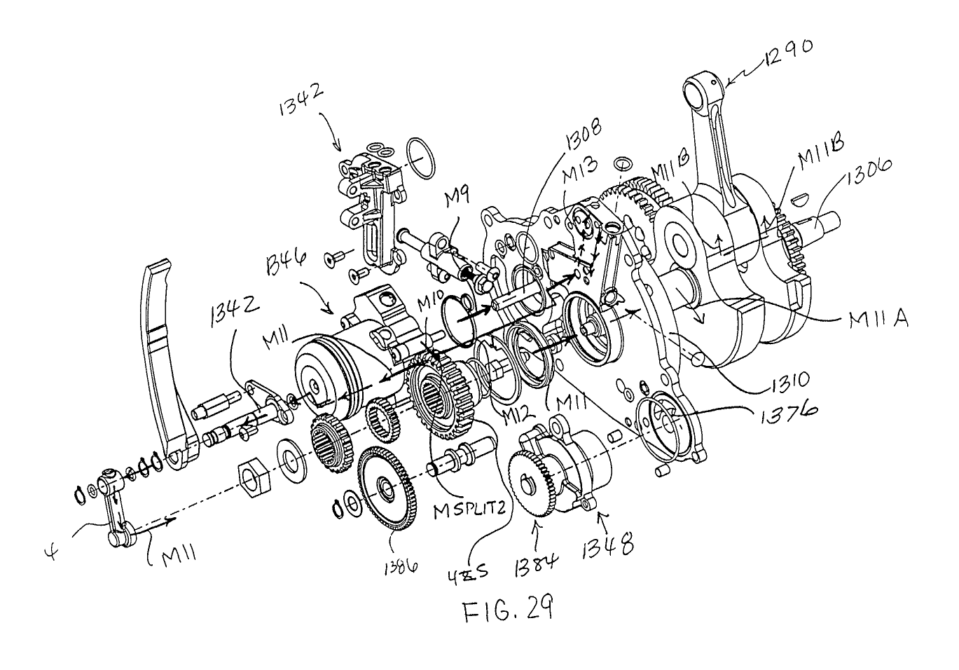

Referring again to FIG. 29, the crank assembly cartridge 1298 further includes a tubular, cam shoe pivot 1342, a crank shaft oil supply bridge 1344 that fluidly connects the interior of the cam shoe pivot 1342 to the interior of the crank shaft 1306. A pressure pump assembly 1346 and a scavenge pump assembly 1348 are mounted onto the crank assembly cartridge plate 1310.

Referring to FIGS. 24-27, during assembly of the engine, the crank cartridge 1298 is installed into the case cavity 1296 so that the connecting rod 1290 is below the cylinder 1218. After the liner 1286 is disposed within the cylinder 1218, the piston is dropped into the cylinder. Piston rod 1291 (as shown in FIG. 25a) is moved through the piston access port 1281b to connect the end 1290a of the connecting rod 1290 to the piston 1284. Cover 1342 (as shown in FIG. 29) is disposed over the port 1281b after the connection is completed.

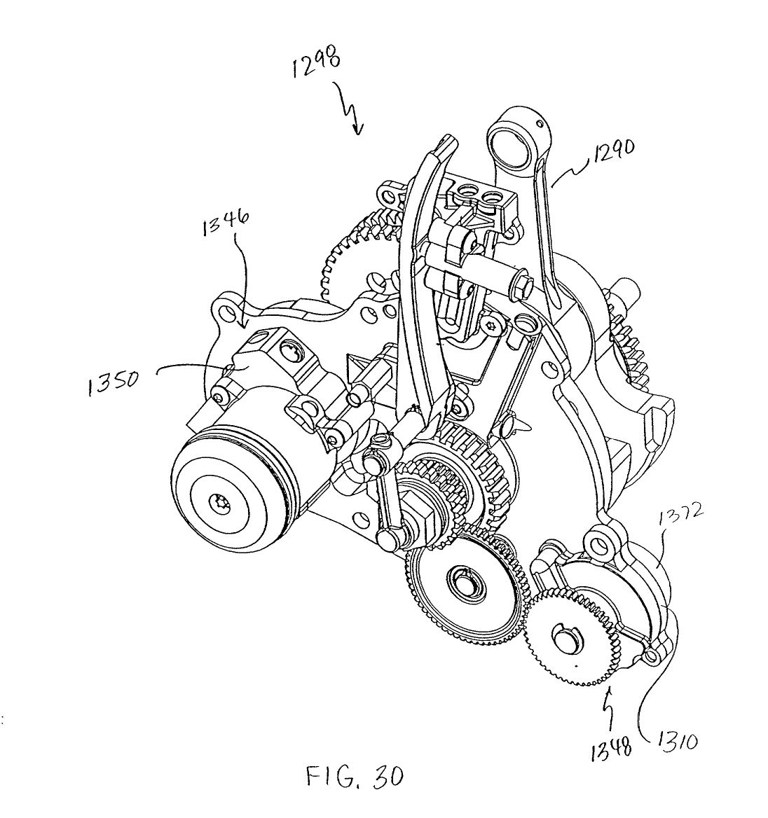

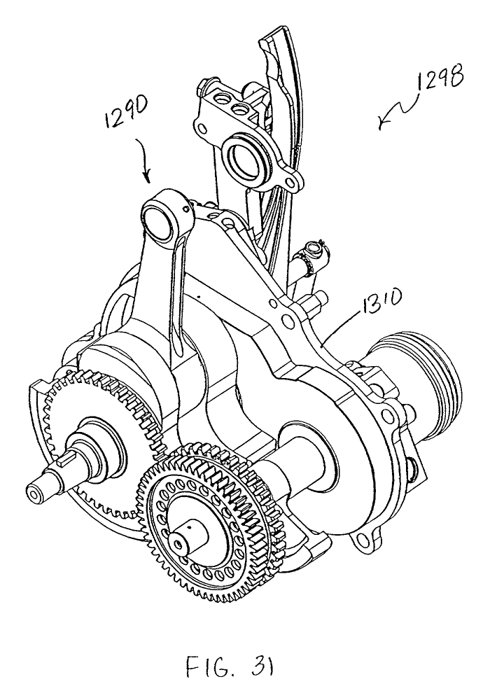

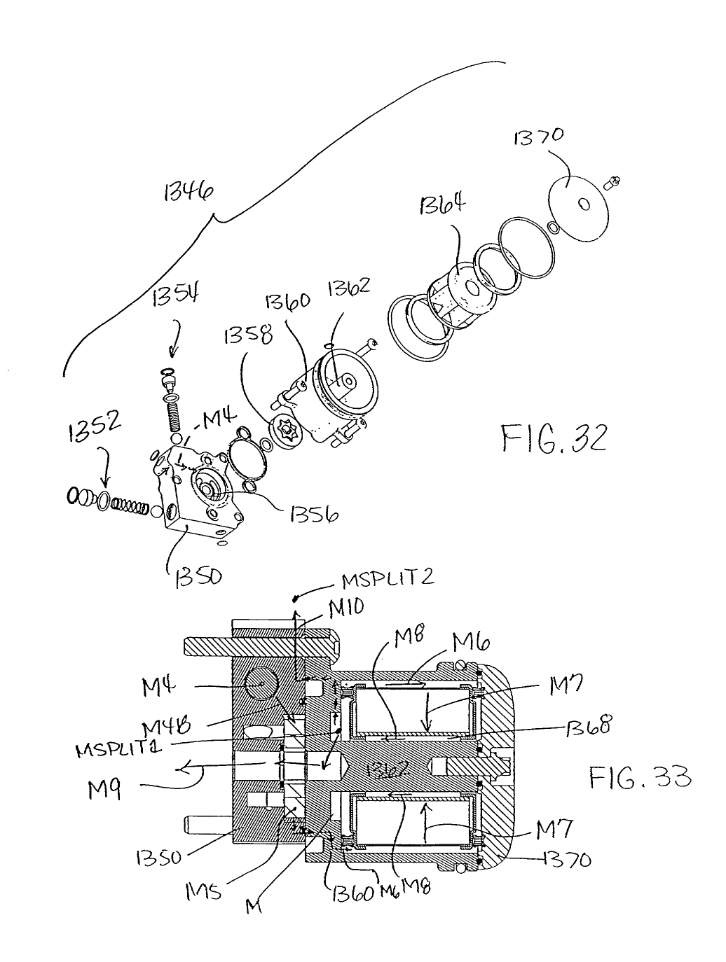

Referring to FIGS. 32 and 33, the pressure pump assembly 1346 includes a housing 1350 that is coupled to the crank assembly cartridge plate 1310 (as shown in FIG. 30). The housing 1350 retains a pressure release valve 1352 and an oil pressure check valve 1354, defines a cavity 1356 for receiving a pressure pump 1358 and defines a plurality of internal passages for fluid communication with the cavity 1356 and the exterior of the housing as discussed in detail below. Pressure pump 1358 is generally known as an eccentric rotor or trochoid pump.

The pressure release valve 1352 and the oil pressure check valve 1354 are spring loaded ball valves. The check valve 1354 prevents flow to engine, when the pressure pump 1358 is not running. In the event of a blockage, the pressure release valve 1352 prevents excess hydraulic pressure from damaging engine components and the oil recirculates within the housing 1350. Both of these valves are conventional.

The pressure pump assembly 1346 further includes a filter housing 1360 mounted on the housing 1350 adjacent the cavity 1356. The filter housing 1360 includes a central shaft 1362 that supports a filter 1364 thereon. The filter 1364 includes a tubular inner screen 1366 (as best seen in FIG. 33) that is coaxial with the shaft 1362. When the filter 1364 is disposed on the shaft 362, a passage 1368 is defined between the screen 1366 and the shaft 1362. The filter housing 1360 also includes internal passages for fluid communication between the passage 1368 and the housing 1350, as discussed below. The pressure pump assembly 1346 further includes a cover 1370 that retains the filter 1364 within the filter housing 1360 and retains the oil within the assembly 1346.

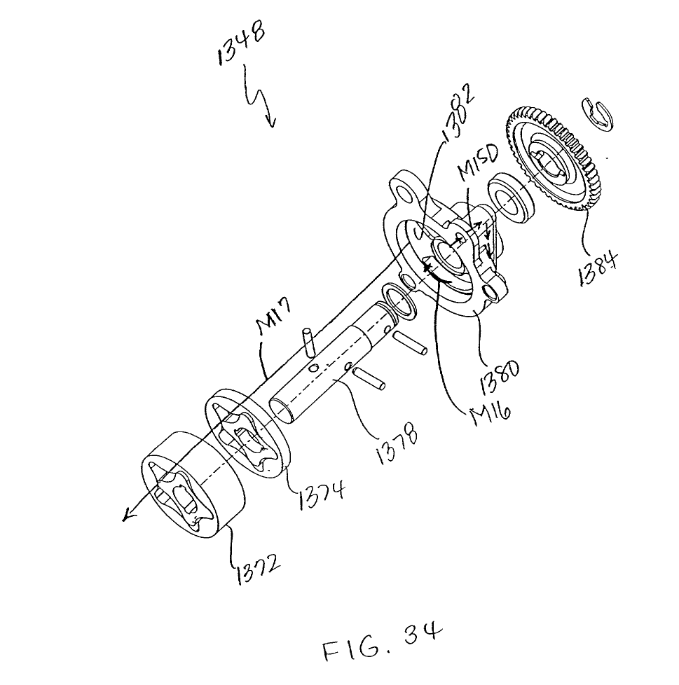

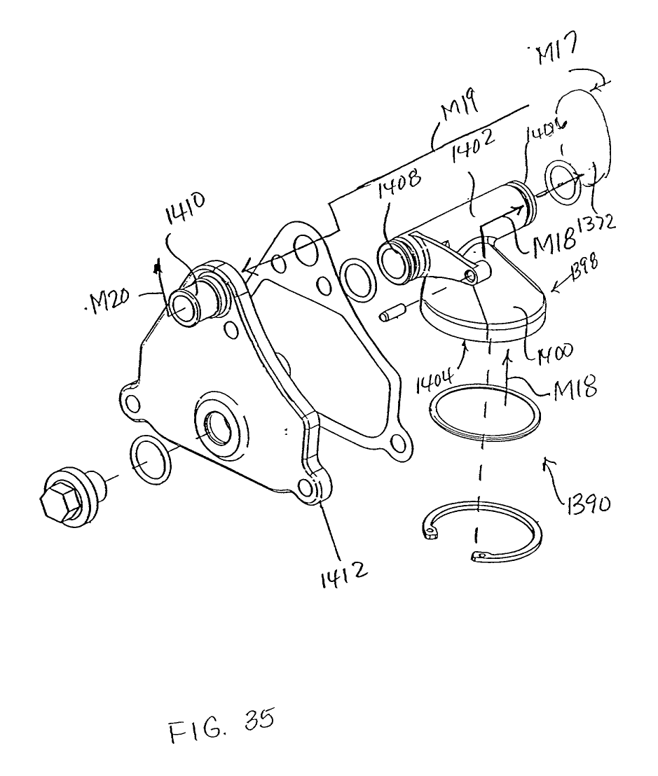

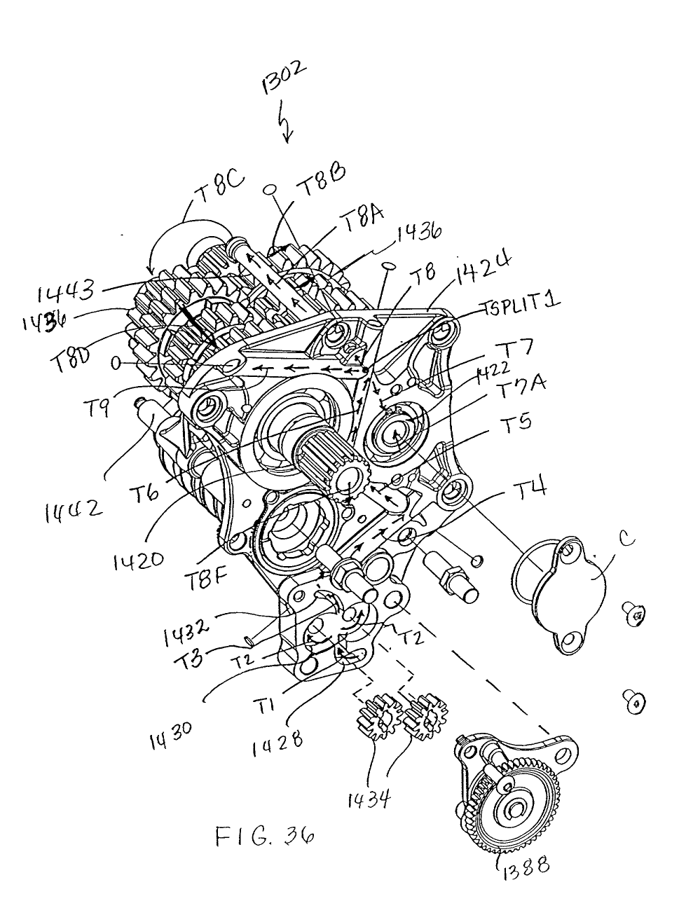

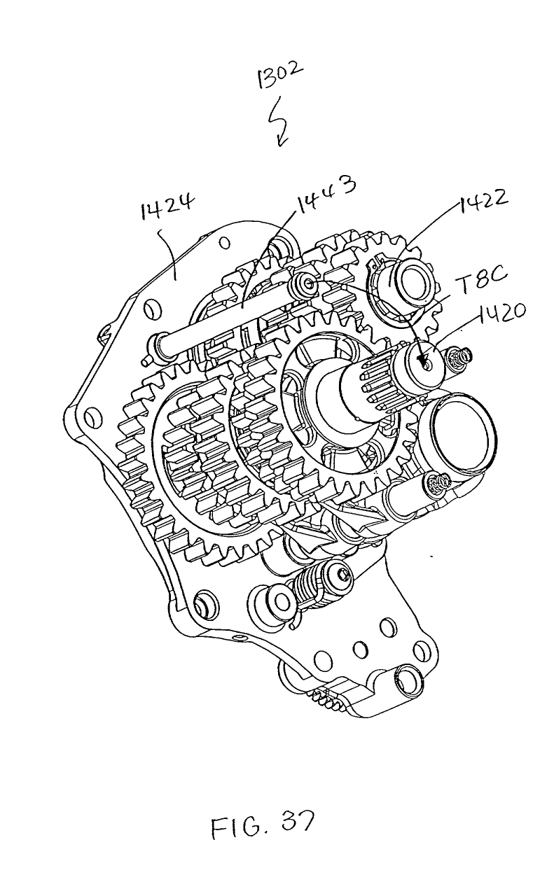

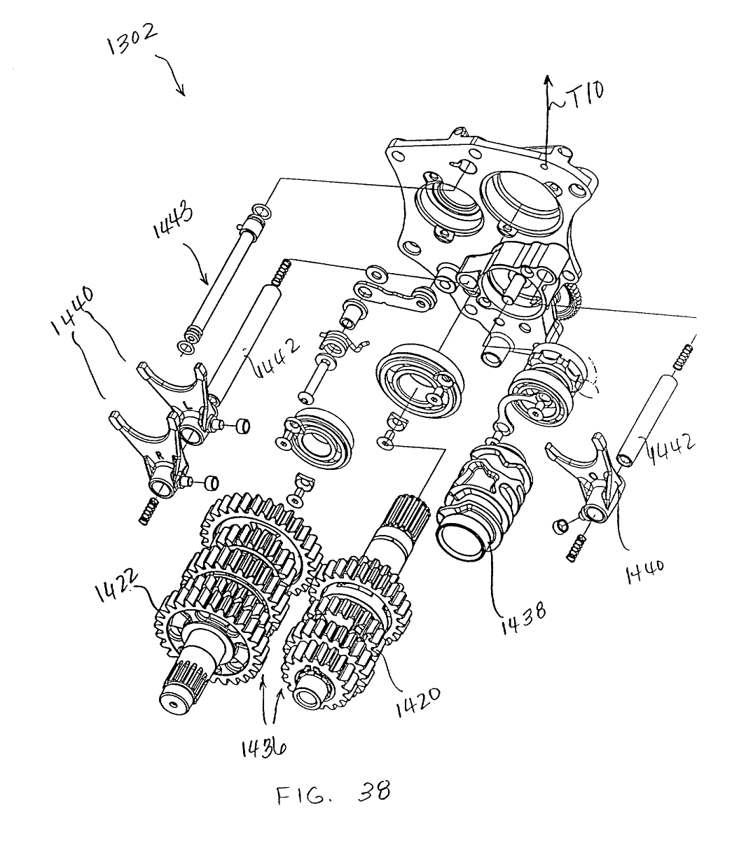

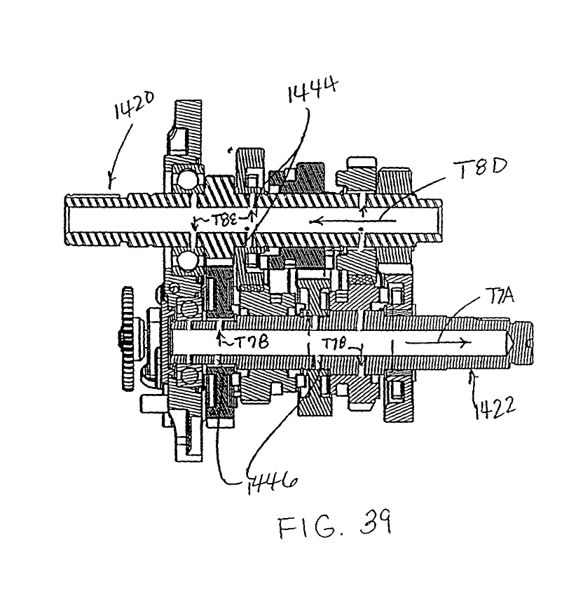

With reference to FIGS. 30 and 34, the motor oil scavenge pump assembly 1348 includes a crank case scavenge pump 1372 that is mounted on one side of the crank assembly cartridge plate 1310 and a cylinder head scavenge pump 1374 that is mounted on the other side of the plate 1310. The pumps 1372 and 1374 are also known as an eccentric rotor or trochoid pumps. The scavenge pump 1372 is in fluid communication with the oil on the floor 1314 of the first cavity 1296 (see FIG. 23). The cylinder head scavenge pump 1374 is in fluid communication with the interior or cam gallery of the cylinder head 1214 (as shown in FIG. 19).

Referring again to FIGS. 29, 30 and 34, the plate 1310 defines an opening 1376 for use by the pump assembly 1348. The pump assembly 1348 further includes a shaft 1378 upon which the pumps 1372 and 1374 are mounted, a pump cover 1380 that defines a cavity 1382 therein and receives the shaft 1378 there through and a scavenge pump drive gear 1384 fixedly coupled to the shaft 1378 for rotating the shaft 1378 and pumps 1372 and 1374. Thus, the components of the assembly 1348 are coaxial. Referring to FIG. 26, the scavenger pump drive gear 1384 meshes with idler gear 1386 and gear box pump drive gear 1388 (as shown in FIG. 36) so that the transmission provides the motive force for the scavenge pump assembly 1348.

Referring to FIGS. 23, 24 and 34, the crank case scavenge pump 1372 is disposed within the first cavity 1296 of the case 1216 within aperture 1297a adjacent wall 1303. Turning to FIG. 35, a sump wing cover assembly 1390 includes a sump wing 1398 with a conical shaped lower portion 1400 and a tube 1402 fluidly connected thereto. The lower end 1404 of the lower portion 1400 is below the oil level within the cavity 1296. One end 1406 of the tube is connected to the aperture 1297c of the wall 1303. The other end 1408 is closed. The conduit 1338 in the case 1216 fluidly connects the aperture 1297c to the outlet 1410 in the cover 1412. A cover 1412 is disposed on the exterior of the case wall 3115 so that the outlet 1410 is adjacent the aperture 1297d.

Referring to FIGS. 27, 36 and 37, the transmission assembly cartridge 1302 includes a clutch drive shaft 1420 and a chain drive or main shaft 1422 that are coupled to and extending through a transmission assembly cartridge plate 1424. In this manner, the entire transmission can be assembled and then inserted into the cavity 1300 of the monocoque cylinder and crank case 1216 and the plate 1424 secured to the periphery 1320 of the wall 1303 (as shown in FIG. 23). This permits easy removal of the transmission assembly cartridge as a unit and easy repair of the transmission. Referring to FIGS. 29 and 14, the gear 1425 on the crank shaft 1306 is coupled to clutch basket 1426 as known by those of ordinary skill in the art, which provides power input to the clutch drive shaft 1420 (see FIG. 36).

Referring to FIG. 36, the plate 1424 defines a plurality of internal passages for transmission oil, as discussed in detail below. Referring to FIG. 26, the fitting (not shown) including the tube 1305 is disposed between the case 1216 and the plate 1424. The internal passages of the plate 1424 are in fluid communication with the internal passages of the fitting so that fluid can flow into the tube 1305 and the other end of the pipe connects to the inlet 1262 (as shown in FIG. 22) of the cam drive shaft support 1276.

Referring again to FIG. 36, the plate 1424 also includes cavities 1428, 1430 and 1432. The lower arcuate cavity 1428 is in fluid communication with the two substantially, circular medial cavities 1430. The medial cavities 1430 are in fluid communication with the upper arcuate cavity 1432. A pair of meshed, sump gears 1434 are rotatably mounted within the medial cavities 1430 and operatively associated with gear box pump drive gear 1388. The lower aperture 1428 is below the oil level on the floor 1322 of the second cavity 1300 (as shown in FIG. 23).

Referring to FIG. 38, the transmission assembly cartridge 1302 further includes a plurality of gears 1436, a shift drum 1438, shift forks 1440 and shift fork rods 1442 for changing gears, and an oil spray bar 1443. As is know by those of ordinary skill in the art, the shift forks 1440 are moved along the shift fork rods 1442 to engage and disengage the gear cogs to change gears. The gears transfer power from the clutch drive shaft 1420 to the chain drive or main shaft 1422. Preferably undercut cogs are used to improve the coupling between gears. As discussed below, a shift drum position sensor (not shown) is coupled to the shift drum 1442 to monitor the engine gear and gear switching. Referring to FIGS. 23 and 38, when the transmission cartridge 1302 is disposed within the case 1216, the gears 1436 are spaced from oil on the floor 1322 of the case 1216.

Referring to FIGS. 38 and 39, the clutch drive shaft 1420 defines spaced, radially extending apertures 1444 and the chain drive shaft 1422 defines spaced, radially extending apertures 1446. The oil spray bar 1443 defines a plurality of apertures. Similarly, as shown in FIG. 29, the crank and balance shafts 1306 and 1308 discussed above, also define spaced, radially extending apertures.

Referring back to FIGS. 26, 27 and 14, once the crank assembly cartridge 1298 and the transmission assembly cartridge 1302 are inserted into the engine case cavities 1296 and 1300, the crank assembly cartridge plate 1310 is removably attached to the first side 1301 of the case 1216 forming a first sealed chamber therein, and the transmission assembly cartridge plate 1424 is removably attached to the first side 1301 of the case 1216 forming a second sealed chamber therein. The first sealed chamber receives the crank shaft 1306, connecting rod 1290, and the balance shaft 1308. The second sealed chamber receives the clutch shaft 1420, the main shaft 1422 both supporting a plurality of gears. The first sealed chamber contains a first or motor oil and the second sealed chamber receives a second or transmission oil.

After the cartridges 1298 and 1302 are attached to the case 1216, the cover 1213 is attached to the outer periphery of the engine left-side to protect the engine. Referring to FIGS. 23 and 36, the clutch drive shaft 1420 is supported in the aperture 1324. The oil spray bar 1443 is supported in another aperture. The main shaft 1422 is supported in the aperture 1328. The shift fork rod 1442 is supported in the aperture 1330.

Referring back to FIG. 6B, the electronic control management system or ECM preferably is programmable and has more than one control map thereon so that different fuel injection/air intake control maps can be selected by the user for different riding conditions.

Referring to FIGS. 6B, 10, and 11D, ECM includes an air temperature sensor and air pressure sensor and a program board. The air temperature sensor is located within the flow of air from the air inlets 828 and 830 and possibly with in the plenum 842. The air temperature sensor measures the temperature therein and the air pressure sensor is positioned near the ECM to measure the ambient air pressure. The measurements from these sensors are electronically fed back to the ECM.

Still further, the ECM includes a throttle position sensor on the throttle body 230. In other words, the throttle is coupled to open and close the throttle body. The throttle sensor is merely a position sensor on the throttle body to determine how open or closed the throttle is.

A crank sensor is coupled to the crank shaft to measure the engine speed for the ECM. Preferably, it provides a signal to the ECM based on the teeth of the generator flywheel, not shown, that mounts to the end of the crank shaft. These signals are fed to the ECM, which provides output signals to the fuel injectors to control the fuel injection into the engine.

The ECM further includes an engine temperature sensor, which is preferably a water temperature sensor 1454 (as shown in FIG. 19) measuring the cooling water temperature before it returns to the radiator. Based on the power desired, which is provided from the throttle position sensor, and the input signals, the ECM system uses a control map to calculate proper control signals for the fuel injection and ignition timing.

In this embodiment, the ECM system is primarily provided on a plate, which is coupled to the top of the gas tank or the cylinder head. As mentioned above, the ignition coil 1272, as shown in FIG. 19, is coupled to the ECM to receive signals therefrom.

In a most preferred embodiment of the invention, the program board receives the input signals from the throttle position sensor, the RPM or crank shaft sensor, the engine temperature sensor, and the air pressure and then provides fuel and ignition control signals to the fuel injectors and ignition coil, respectively, based on these input signals and the programmed control map. The board is preferably programmed with more than one control map for providing fuel and ignition control signals to the engine such that the user can readily switch between control maps. More particularly, for example, a control map can be provided for dry conditions and a separate control map can be provided for muddy conditions and a switch on the handle bars can be provided for switching between these two control maps. In this manner, when the user shows up to a track early in the morning when the track is in muddy conditions, the user can select a first, muddy control map which would preferably provide less low end torque. In the afternoon when the track dries up, the rider can readily switch to a second, dry conditions control map which will provide higher torque at the low end. Still further, an infrared reader can be coupled to the board so that a user can modify or make different control maps on their computer and quickly download them onto the control board for readily changing the control maps of the fuel injection and ignition.

In a preferred embodiment of the invention, the ECM includes an ignition interrupt, whereby the spark to the engine is stopped during gear changes such that there is little load on the transmission and gear changes are much easier and smoother. In the preferred embodiment, the ECM system includes the shift drum position sensor to provide a signal when the user is changing gears and the ECM system shuts down the ignition spark during the gear change.

Still further, in a preferred embodiment of the invention, the ECM includes separate ignition timing for each gear such that the lower gears can have an advanced ignition timing based on piston position such that the bike can accelerate faster through low gears. Then, a retarded timing is used for the higher gears where acceleration has slowed. Most preferably, the ECM system includes at least one base map (as stated above different base maps can be used for different riding conditions) and then a gear modifier to make the ignition timing gear specific. Preferably, the shift drum position sensor provides a signal to the ECM indicating which gear the engine is in and the gear modifier moves ignition timing inversely proportional to the gear, i.e., first gear has the most advanced timing (earliest or lowest in the piston stroke) and the highest gear has the most retarded timing. Most preferably, the ignition timing with regard to piston position changes for each gear such that the timing is less advanced or more retarded for each higher gear. That is the ignition timing occurs at a higher point in the piston travel for each higher gear. As is well known in the art, advanced timing is when the ignition takes place during the up stroke of the piston, before the piston reaches the base position, and retarded ignition takes place during the up stroke of the piston, after the base position and before the piston reaches top-dead-center. Therefore, more advanced ignition means that the piston is further away from top-dead-center in the stroke.

Still further, the engine of the present invention preferably includes a cam position sensor 1459, as shown in FIG. 19, that provides the ECM with a cam location and speed signal. Although the speed signal is somewhat redundant to the crank shaft sensor, the cam position sensor indicates to the ECM where in the four-stroke cycle the piston is in. This is particularly important during starting when it is undesirable to have ignition during the exhaust stroke as opposed to the compression stroke (both upward movements of the piston). Generally on a single cylinder engine, this could cause backfire. Thus, the cam position sensor can make sure that the start-up ignitions are in the proper timing of the four-stroke cycle.

Referring to FIGS. 12 and 29, the improved four-stroke engine preferably has only an electronic starter 1210. Preferably, the starter 1210 is coupled to a first end of the engine motor balance shaft 1308.

The invention is also directed to an engine with an ECM system that allows for after market tuning. While the ECM system automatically compensates for air temperature and pressure, consumers may buy after market parts and may want to change the fuel map or ignition timing. The present invention adds a pig tail connector/harness that plugs into a connector on the ECM system. When plugged in, the ECM system is programed to know that the engine is in either a service or tuning mode and the user can select the mode with a switch on the pig tail connector/harness. In service mode, the ECM will signal if there is a malfunction such as bad sensor. In the tuning mode, the engine is started in neutral and then an ECM system potentiometer is altered to adjust the idle. Then the engine can be switched into gear to adjust the low, mid and high range fuel characteristics. For example, the engine can be placed into second gear and the potentiometer adjusted to adjust the low range fuel characteristics. Then the engine can be switched into third gear and the potentiometer altered to change the mid range fuel characteristics. Finally, the engine can be switched into fourth gear and the potentiometer altered to change the high range fuel characteristics. Preferably, a signal from the throttle sensor can be used to save the changes and then the engine is tuned to the user's desires.

In one embodiment, the ECM can be in communication with a Global Positioning System (GPS) so that data from the GPS can be shared with the ECM. This data can be used, for example to display the rider's position and/or to give the rider directions.

In another embodiment, sensors can be provided on the rotatable members that support the front and rear wheels 7 and 8, such as the axle 152 (as shown in FIG. 7). This sensor is in electronic communication with the ECM to provide data on the wheel speed. When braking is desired, rather than or in addition to providing brake acutators on the handle bars 119 the control of the brake calipers can be directed by the ECM based on the wheel speed data and pre-set limits.

In yet another embodiment, the rider could have heads-up display in their helmet that receives data from the ECM. The type of data that the ECM could provide the rider includes, for example, wheel slippage, water temperature of the cooling water, engine inlet air temperature, ignition timing, vehicle ground speed, and revolutions per minute of the crank shaft sensor.]

The transmission oil flow path will now be discussed with reference to FIG. 14 and 36. The transmission oil provides lubrication for among other components, the cavity 1300 (as shown in FIG. 23) or gear box, bearings of the main shaft 1422 and clutch shaft 1420, cam gears 1258a-d, cam drive chain 1260, the clutch 1426, idler gear 1386, scavenger pump drive gear 1384, and gear box pump drive gear 1388 among other components.

Referring to FIGS. 36 and 23, the lower arcuate conduit 1428 is below the level of the transmission oil in the second cavity 1300 so that when the sump pump gears 1434 rotate they draw oil from floor 1322 of cavity 1300 into groove 1428, as labeled T1. A screen is disposed upstream of the sump pump gears 1434 to filter the oil prior to entering the gears. The oil then flows around gears 1434, as labeled T2, and flows up upper arcuate groove 1432 as labeled T3. The internal passages in the plate 1424 direct zig-zag flow upward, as designated T4 that flows generally in a first direction, T5 that flows generally in a second, opposite direction, T6 that flows in generally the first direction. Then, the oil flow splits three-ways at the point TSPLIT1.

After the split TSPLIT1, the first path of the oil flows, as labeled T7, in internal passages in the plate 1424 to bearings about main shaft 1422. Due to cover C, the oil is then directed into the interior of the main shaft 1422, as labeled T7A. As shown in FIG. 39, apertures 1446 in main shaft 1422 allow bearings on shaft 422 to be lubricated, as labeled T7B. Referring again to FIG. 36, after the split TSPLIT1, the second path of the oil flows, as labeled T8 toward oil spray bar 1443, and there through as labeled T8A. When oil flows through oil spray bar 1443, apertures there through allow oil to escape and spray onto the gears 1436, as labeled T8B. The sprayed oil drops to the floor 1322 (as shown in FIG. 23) of the cavity 1300.

Turning again to FIG. 36, excess oil from the oil spray bar 443 flows from the bar to the interior of the clutch shaft 1420, as indicated T8C. Referring to FIGS. 36 and 24, the conduit 1319 in the case allows flow T8C between the oil spray bar 1443 and clutch shaft 1420. Flow T8D flows through the interior of the clutch shaft 1420 and apertures 1444 therein shown in FIG. 39 allow oil to spray the bearings on shaft 1420, as labeled T8E.

Referring again to FIG. 36, excess flow from the end of the clutch shaft 1420 drips from the clutch shaft 1420 to lubricate other exterior components on the cartridge 1302.

After the split TSPLIT1, the third path of the oil flows is within the internal passages in the plate 1424 upward, as designated T9. The oil then flows through the plate 1424 and upward as labeled T10 (shown in FIG. 38). The flow upward T10 is actually through the tube 1305 (as shown in FIG. 26).

Referring to FIG. 18, the flow T10 enters the inlet 1276b of the cam drive shaft support 1276 and splits at point TSPLIT2. A portion of the flow moves through internal passages of the cam drive shaft support 1276 and exits the port 1276b to lubricate the cam drive chain 1260 (as shown in FIG. 14) and other exterior components, such as the clutch and gears, there below.

Since the transmission gears 1436 are spaced from the oil on the floor 1322 (as shown in FIG. 23) of the case, the cartridge 1302 has pump gears 1434 and an oil spray bar to actively lubricate the gears 1436.

Referring again to FIG. 18, from the split TSPLIT2 another portion of the flow moves through internal passages of the cam drive shaft support 1276 and through internal passages in the idler shaft support bracket 1277 to the port 1277a, as labeled T12. Spray T12 from the port 1277a lubricates the gears 1258a-c on the cylinder head 1214. Excess oil from the sprays T11 and T12 falls to the floor 1322 (as shown in FIG. 23) of the case 1216 and the cycle repeats with the flow into the cavity 1428 from the floor 1322 due to the rotation of the sump pump gears 1434 (as shown in FIG. 36).

Now, flow of the engine or motor oil in the engine will be discussed with reference to FIGS. 19 and 27. The motor oil lubricates among others the piston 1284, crank shaft 1306 and balance shaft 1308, and the components within the cam gallery such as the cams 1250 and cam shafts 1254 and 1256.

Referring to FIGS. 6A and 6B, oil flows down the left spar 33, as labeled M1, and through the outlet 845. Oil flows out of the outlet 845 and into the inlet O (as shown in FIG. 26) of the case, as designated M2 via a conduit (not shown) there between. The inlet O includes an oil filter that is upstream of the oil filter within the pressure pump assembly 1346. The inlet O oil filter is a tubular screen with a cap of screen of material on one end.

Referring to FIG. 26, oil flows from the inlet O toward the oil pressure pump housing 1350 through internal passages in the cartridge plate 1310. This flow is designated M3A and M3B. Referring to FIG. 26 and 32-33, oil flows into internal passages in the housing 1350 as designated M4 to the cavity 1356 that contains the pump 1358. Oil is pumped by the pump 1358 and becomes pressurized and flows to the circumferentially spaced other side of the housing 1350 as M5 then through internal passages in the housings 1350 and 1360. Then it flows between the filter housing 1360 and the filter 1364, as labeled M6. The oil then passes through the filter 1364 to the passage 1366, as labeled M7. Oil then flows into a manifold M and splits at point MSPLIT1.

The first flow from MSPLIT1 flows through internal passages in the housing 1350 as M9 to the interior of the balance shaft 1308 (as shown in FIG. 28). The balance shaft 1308 has apertures through which oil sprays as M9A for lubricating the bearings on the balance shaft. The end 1308a of the balance shaft 1308 is closed so that the oil can exit only through the apertures.

Referring to FIG. 33, from MSPLIT1 the second flow of oil M10 flows through internal passages in the housing 1350 as M10, then splits two ways at MSPLIT2. Referring to FIG. 29, after MSPLIT2, the first part of the oil flows through the cam shoe pivot 1342, elbow 1344, and through the center of the crank shaft 1306 to a dead end. Apertures through the crank shaft allow the oil flow, as labeled M11A, there through to exit the shaft 1306 to lubricate the bearings on the crank shaft. Excess oil flows through the shaft 1306 and exits ports to spray the bearings of the connecting rod 1290, as labeled M11B.

Referring to FIG. 29, after MSPLIT2, the second part of the oil M12 flows toward crank assembly cartridge plate 1310 and there through in internal passages, as shown in FIG. 28, where the path splits at point MSPLIT3. Flow M13 from MSPLIT3 moves upward and flow M12B from MSPLIT3 moves through internal passages in the crank assembly cartridge plate 1310 to exit from port P as spray M12C. Spray M12C lubricates the bottom of the piston and the roller bearing in the end 1290a of the connecting rod 1290.

Referring to FIG. 29 and 18, flow M13 continues upward through conduit 1279 as M13A to the cylinder head 1214. Referring to FIG. 22, flow M13A flows into the center of the assembly 1238 after entering inlet 1262 and splits two ways at MSPLIT4, labeled M13B and M13C. Flows M13B and M13C travel through internal passages 1264a and 1264b respectively. As shown in FIGS. 21 and 22, the flows M13B and M13C, move across the cam gallery floor as flows M13D and M13E, and flow out of the spray ports 1266a and 1266b as the spray M14B and M14C respectively. Spray from the ports moves upward into the cam gallery and lubricates the valve train, such as in FIG. 19, the cams 1250, cam shafts 1254 and 1256. The spray M14B and M14C are generally directed toward the cams, but also lubricate the other valve train components. Spray M14B and M14C falls from the valve train to the cam gallery floor and flows as M15A out of the outlet port 1264 best seen in FIG. 22.

Referring to FIGS. 18,22 and 28, from the cylinder head port 1264 flow M15A becomes downward flow M15B which moves through conduit 1278 downward. Conduit 1278 is connected to the internal passages defined in the crank assembly cassette plate 1310, and the flow then moves downward there through, as labeled M15C, (as best shown in FIG. 28).

Referring to FIG. 26, flow M15C continues through internal passages within the crank assembly cassette plate 1310, as flow M15D, to the scavenge pump cover 1380 and through passages in the cover 1380 (as best shown in FIG. 34). From the cover 1380, flow M15D enters the cavity 1382 therein and the cylinder head scavenge pump 1374 rotates causing oil in the cavity 1382 to rotate M16 and draws oil across cylinder head scavenge pump 1374 as M17. Thus, the cylinder head scavenge pump 1374 draws oil from the cylinder head actively. The flow M17, then flows through crank assembly cassette plate 1310 (as shown in FIG. 30) and through crank case scavenge pump 1372.

Referring to FIGS. 34 and 23, the crank case scavenge pump 1372 is located within the cavity 1297a of the case. Referring to FIGS. 23, 24, 34 and 35, the case scavenge pump 1374 draws oil from the floor 1314 of case cavity 1296 through the lower end 1404 of the sump wing 1398 and flows this oil to the transverse tube 1402 as M18. Flows M17 and M18 combine as the pump 1372 rotates to form flow M19, which flows transversely through conduit 1338 (as shown in FIG. 23) to cover conduit 1410 and exits as M20.

Referring to FIGS. 35 and 6A, flow M20 enters cross member 35a through inlet 847 as flow M21. The inlet 847 and the outlet 1410 are in fluid communication through a conduit (not shown). Flow M22 then moves across cross member 35a and air vents from within the engine through the outlet 849. Flow M22 then goes into the left spar 33 as M1 (as shown in FIG. 6B) and the motor oil cycle repeats.

Referring to FIG. 34, the cylinder head scavenge pump 1374 is smaller than the crank case scavenge pump 1372, because the cylinder head scavenge pump 1374 pulls oil down from the cam gallery while the crank case scavenge pump 1372 must draw oil from the floor of the case.

The cooling water system and water flow path will now be discussed with reference to FIGS. 6D, 17, and 26. Beginning at the radiator 57, water is drawn from the radiator 57 through the outlet 1206 to the inlet 1275 on the water pump cover 1274 via the conduit 1210 by rotation of the wheel 1273 (see FIG. 19). This flow is labeled by the arrow W1. The water in the cover 1274 flows into the cylinder head cooling water inlet that is in fluid communication with apertures 1236 so that water flows through the apertures 1236, as indicated by the arrows W2.

Water then flows from the apertures 1236 into the cylindrical groove 1287 between the cylinder liner 1286 and the cylinder 1218, as indicated by the arrow W3. This allows the water to surround the piston 1284 and cool the engine.

Now, referring to FIGS. 26 and 25, the flange 1286a and ledge 1281c along with optional gaskets prevent the water in the groove 1287 from flowing into the lower portion 1218a of the case 1216. From the cylindrical groove 1287 water exits the cylinder 1218 via the water outlet port 1281a. The elbow 1288 on the port 1281a directs the water flow W4 from the cylinder. Turning again to FIG. 6D, the water flow from the elbow 1288 flows toward the radiator 57 via the conduit 1212 and into the radiator inlet 1208, as indicated by the arrow W5.

Referring to FIG. 6D, within the radiator 57, the water from the inlet 1208 flows downward in a serpentine path so that it is air cooled and exits through the water outlet 1206 to begin the cooling cycle again.

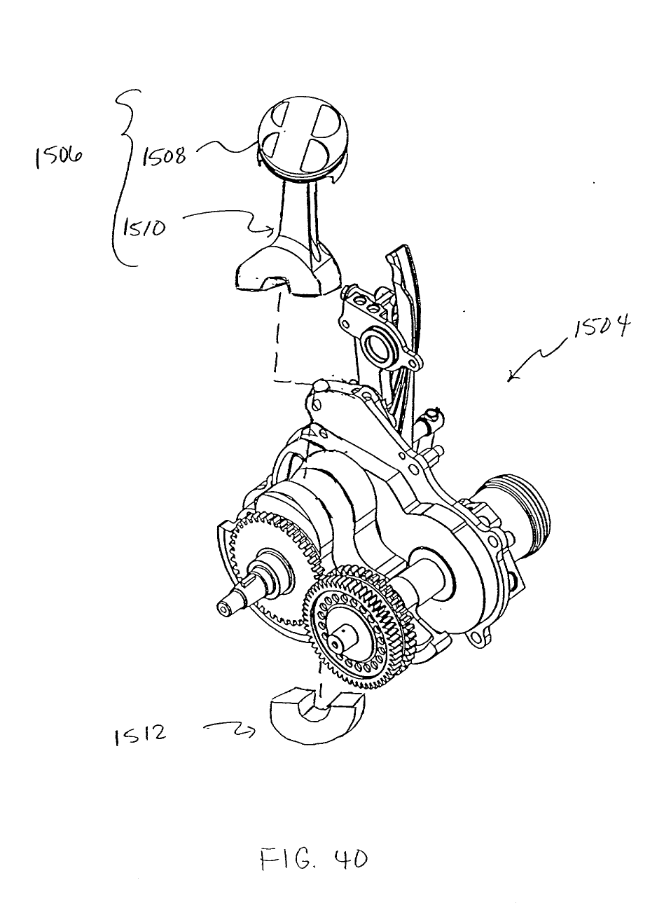

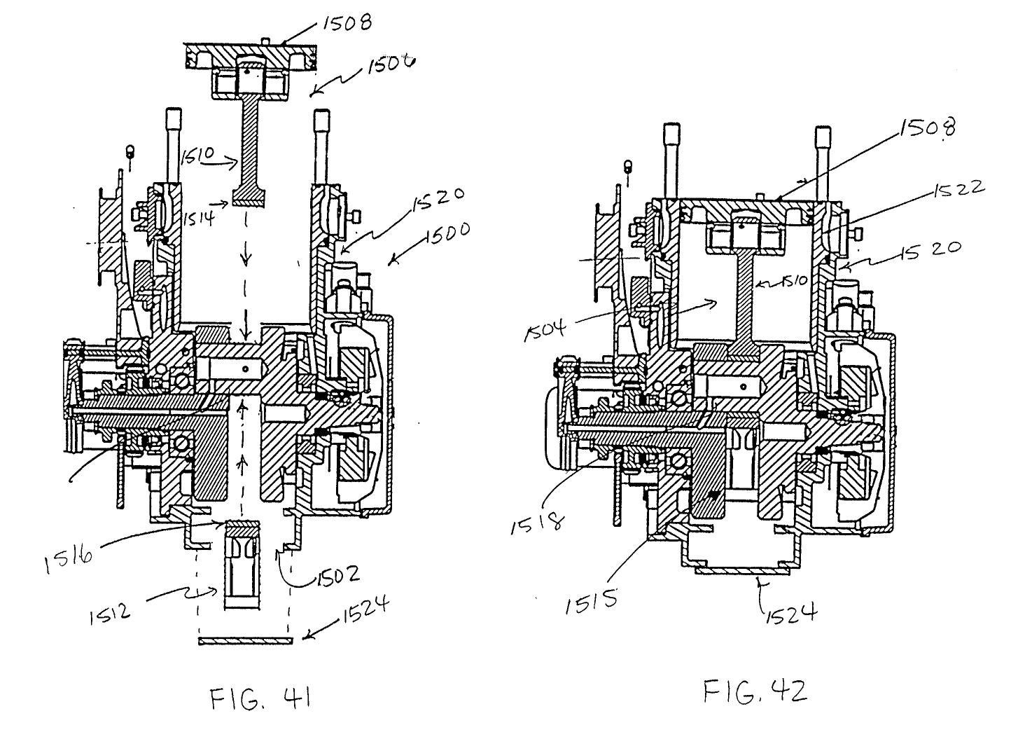

Referring to FIGS. 40 and 41, in another embodiment, monocoque cylinder and crank case 1500 defines a hole 1502 in the bottom. The crank cartridge assembly 1504 is operative connected to a separate connecting rod subassembly 1506. The connecting rod subassembly 1506 includes a piston 1508 operatively connected to an upper portion of a connecting rod 1510. A lower portion 1512 of the connecting rod is also used. Both the connecting rod subassembly 1506 and the lower portion 1512 include associated bearings 1514 and 1516 (as seen in FIG. 41).

During use of the monocoque case 1500, the cartridge assembly 1504 is installed in the case, as discussed above, so that the crank shaft 1518 is disposed within the case 1504. Then the connecting rod subassembly 1506 is aligned with the cylinder 1520 from above the cylinder and the lower portion 1512 of the connecting rod is aligned with the cylinder 1520 below the case 1500. The subassembly 1504 is lowered into the case 1500 through the cylinder 1520. The lower portion 1512 of the connecting rod is raised into the case through the hole 1502 until the subassembly 1504 and the lower portion 1512 are operatively connected to one another about the crank shaft 1518, as shown in FIG. 42. In this position, the piston 1508 is within the cylinder 1520 adjacent the cylinder liner 1522. Then, a cover 1524 is disposed over the hole 1502 to seal the chamber within the case 1500.

While it is apparent that the illustrative embodiments of the invention disclosed herein fulfill the objectives stated above, it is appreciated that numerous modifications and other embodiments may be devised by those skilled in the art. For example, the crank assembly cartridge includes a balance shaft, however the cartridge can be formed without the balance shaft. In addition, aspects of the present invention can be used with multiple cylinder engines, such as V-twins. The frame can be modified to function with an independent suspension where the rear wheels are on separate axles. Although the vehicle is shown with four wheels a three-wheel vehicle with one front wheel can use the frame, subframe, swing arm, and other components of the development above as know by those of ordinary skill in the art.

Although the vehicle described above is used to transport a rider to around, the vehicle could be set up on a platform in a video-simulator so that it stays in one location. The rider or operator could adjust various parameters (such as steering setting) on this stationary vehicle and see how these adjustments affect the handling of the vehicle with reference to a screen. This stationary vehicle could be mounted and the platform configured to provide feedback to the rider such as vibration in the handle bars, and sideways and/or front-back tilting.

In an alternative embodiment, the transmission can be omitted and an electric motor (or hub or servo- motor) can be provided at each wheel to provide power to the wheels. Thus, no gearbox and clutch are necessary. In this arrangement, these motors can be controlled by software in the ECM. Thus, each wheel can be operated at different speeds if desired. The speed differential between wheels can be used to steer the vehicle. This allows four-wheel steering and/or steering settings to be provided to match the driver's preferences. Some examples of such steering settings or modes are uphill, downhill, traction control, and hill-descend. Steering can also be done by steering the front pair of wheels one direction and the rear pair of wheels in the other direction or steering all of the wheels independently in different directions.

In this embodiment, software in the ECM can control power delivery to each wheel. The software can also have settings for different riding styles and different terrain. Examples of different riding styles that can have settings are fast desert riding, slow technical, or woods riding. Examples of different terrain that can have settings are mud, sand, snow, grass, and the like.

The proper settings can be chosen by the rider or a technician. The rider can also adjust parameters such as wheel speed and turn angle to change driving style (i.e., under steer, where the vehicle wants to continue moving forward or over steer, where the rear end wants to come around.)

These settings can be posted and downloaded from a separate computer or the internet so that riders can optimize settings for their area or terrain. With this type of arrangement the vehicle steering can also be remote controlled by, for example, a computer with a wireless modem.

The features of one embodiment can be used with the features of another embodiment. Therefore, it will be understood that the appended claims are intended to cover all such modifications and embodiments which would come within the spirit and scope of the present invention.

We claim:

1. A frame for a vehicle with at least one wheel on either side of a central, longitudinally extending plane of the vehicle, wherein the vehicle is rider with a rider astride the vehicle, wherein the frame comprises:
a) a front frame for supporting at least one front wheel of the vehicle; and
b) a main frame including
(a) first and second spars, each spar including a first portion that extends substantially horizontally rearward, and a second portion that extends downwardly and rearwardly from the first portion and each terminating at free ends that are spaced apart, and
(b) first and second swing arm mounts on the first and second spars respectively, the first swing arm mount extends downwardly from the first spar free end and terminates in a mount free end, the second swing arm mount extends downwardly from the second spar free end and terminates in a mount free end
(c) an engine frame to which an engine is releasably attached, the engine frame being removably connected to the front frame and the swing arm mounts at the mount free end.

2. The frame of claim 1, wherein the main frame further includes at least one cross member extending between the spars, the cross member includes a first shock mount extending therefrom.

3. The frame of claim 2, further including a swing arm including two spaced stays, a first end pivotally connected to the swing arm mounts, a spaced second end having an axle assembly rotatably attached thereto, and a swing arm cross member that extends transversely between the stays, the swing arm cross member having a second shock mount extending therefrom; and
c) a shock pivotally connected to the first shock mount and the second shock mount, wherein the shock lies coincident with the central plane.

4. The frame of claim 3, wherein the shock travel angle between a fully extended position and a fully compressed position is between about 15 degrees and about 25 degrees.

5. The frame of claim 3, wherein the swing arm stay includes a plurality of integrally molded brake caliper mounts.

6. The frame of claim 3, where in the axle assembly includes an axle supporting at least one brake disk.

7. The frame of claim 6, wherein the axle is formed of carbon fiber or steel.

8. A fuel tank for use with a vehicle having at least one wheel on either side of a central longitudinally extending plane of the vehicle, wherein the vehicle is ridden with a rider located substantially on the central longitudinally extending plane, wherein the fuel tank comprises:
a) an upper wall;
b) a lower wall spaced from the upper wall;
c) a sidewall joining the upper wall to the lower wall to form
(1) a first hollow portion defining a fuel inlet for introducing a fuel therethrough;
(2) a second hollow portion including a fuel outlet disposed therein for egress of the fuel therefrom; and
(3) at least one central hollow portion for connecting the first hollow portion to the second hollow portion so that the fuel travels from the first hollow portion to the second hollow portion.

9. A fuel tank for use with a vehicle having at least one wheel on either side of a central longitudinally extending plane of the vehicle and a seat located substantially on the central longitudinally extending plane, wherein the vehicle is ridden with at least one rider located substantially on the seat, wherein the fuel tank comprises:
a) an upper wall;
b) a lower wall spaced from the upper wall;
c) a sidewall joining the upper wall to the lower wall to form
(1) a first hollow portion defining a fuel inlet for introducing a fuel therethrough;
(2) a second hollow portion including a fuel outlet disposed therein for egress of the fuel therefrom; and
(3) at least one central hollow portion for connecting the first hollow portion to the second hollow portion so that the fuel travels from the first hollow portion to the second hollow portion;
wherein the fuel tank is located substantially below the seat.

10. The fuel tank of claim 9, wherein the second hollow portion is located below the seat.

11. The fuel tank of claim 9, wherein the second hollow portion is located rearwardly of the engine.

12. The fuel tank of claim 10, wherein a volume within the second hollow portion is greater than a volume within the first hollow portion.

13. The fuel tank of claim 10, wherein the fuel tank has a volume and the volume of the second hollow portion is at least two-thirds of the volume of the tank and the second hollow portion is below the first hollow portion.

14. The fuel tank of claim 10, wherein a volume within the second hollow portion is approximately twice a volume within the first hollow portion.

15. An engine for use with a vehicle having at least one wheel on either side of a central longitudinally extending plane of the vehicle and a seat located substantially on the central longitudinally extending plane, wherein the vehicle is ridden with at least one rider located substantially on the seat, wherein the engine comprises:
a) a cylinder for receiving a piston;
b) a crank case coupled to the cylinder defining a first sealed chamber for receiving a crank shaft and a connecting rod and a second sealed chamber for receiving a plurality of gears; and
c) a first oil in the first chamber and a second oil in the second chamber, the second oil having different physical properties than the first oil;
wherein the cylinder and the crank case are formed as a single casting.

16. A vehicle having at least one wheel on either side of a central longitudinally extending plane of the vehicle and a seat located substantially on the central longitudinally extending plane, wherein the vehicle is ridden with at least one rider located substantially on the seat, wherein the vehicle comprises:
a. an engine;
b. a frame for supporting at least the engine, the frame including two spars;
c. a front body panel located above and connected to the front of the frame;
d. at least one aperture defined in the front molded body panel; wherein the aperture is fluidly connected to an engine air intake.

17. The vehicle of claim 16, wherein the engine air intake is in the front of the engine

18. The vehicle of claim 16, wherein the front body panel further comprises:
at least one elongated air dam for directing air into the aperture.

19. The vehicle of claim 16, wherein the engine is selected from a group consisting of: a four-stroke engine, a turbine engine, a diesel engine, or a gas two-stroke engine.

20. The vehicle of claim 19, further including at least three wheels rotatably connected to the frame, wherein the wheels are powered by the engine through a transmission.

21. The vehicle of claim 16, further including at least three wheels rotatably connected to the frame, and a plurality of servo-motors, each servo-motor powers an associated wheel.

22. The vehicle of claim 21, further an electronic control management system for controlling the servo-motors to steer the vehicle.
